(19) United States
(12) Patent Application Publication
(10) Pub. No.: US 2024/0361710 A1
(43) Pub. Date: Oct. 31, 2024

(54) IMAGE FORMING SYSTEM AND IMAGE FORMING METHOD

(71) Applicant: Konica Minolta, Inc., Tokyo (JP)

(72) Inventors: Yukiko NAKAI, Kawasaki-shi (JP); Michiaki ISHIKAWA, Sagamihara-shi (JP); Yusuke TAKIGAURA, Tokyo (JP); Junya ONISHI, Tokyo (JP); Keiji ARAI, Tokyo (JP)

(21) Appl. No.: 18/644,520

(22) Filed: Apr. 24, 2024

(30) Foreign Application Priority Data
Apr. 27, 2023 (JP) 2023-073381

(51) Int. Cl. G03G 9/087; G03G 9/08; G03G 9/097; G03G 15/09

(52) U.S. Cl. CPC G03G 9/08755; G03G 9/0819; G03G 9/09725; G03G 15/0928; G03G 2215/0604

(57) ABSTRACT

An image forming system includes, an electrostatic charge image developing toner; and a developing sleeve configured to convey the electrostatic charge image developing toner, wherein a toner particle included in the electrostatic charge image developing toner contains an amorphous polyester, the amorphous polyester is a polycondensate of a polyvalent carboxylic acid and a polyhydric alcohol, a content percentage of a structural unit derived from a bisphenol A derivative in the amorphous polyester is 10 mol % or less with respect to all structural units derived from the polyhydric alcohol, and the developing sleeve includes an aluminum alloy including more than 0.6% by mass of silicon.

### CROSS-REFERENCE TO RELATED APPLICATIONS

The entire disclosure of Japanese Patent Application No. 2023-073381, filed on Apr. 27, 2023, including description, claims, drawings and abstract is incorporated herein by reference in its entirety.

### BACKGROUND OF THE INVENTION

### Technical Field

The present invention relates to an image forming system and an image forming method. More specifically, the present invention relates to an image forming system and the like in which image failure such as black spots and fogging is suppressed and which is excellent in low-temperature fixing ability and heat resistance.

### Description of Related Art

From the viewpoint of energy saving in recent years, an electrostatic charge image developing toner to be used in image formation is desired to be excellent in low-temperature fixing ability. As the electrostatic charge image developing toner, a toner containing an amorphous polyester and a crystalline polyester as binder resins has been developed, for example, as in Japanese Unexamined Patent Publication No. 2007-279714. Hereinafter, the “electrostatic charge image developing toner” is also referred to simply as the “toner”.

In production of the amorphous polyester, a bisphenol A derivative is often used. Since the bisphenol A derivative has a structure containing many aromatic rings, the molecule is rigid and very difficult to move, and has a characteristic of inhibiting the meltability of the resin. Therefore, it is disadvantageous for low-temperature fixing, and there remains a concern in terms of environmental load.

Therefore, there is a demand for the development of a toner using a small amount of a bisphenol −A derivative as in, for example, Japanese Unexamined Patent Publication No. 2017-062344. It has been found that when the amount of the bisphenol A derivative used is reduced, a problem arises in that image failure such as black spots occurs. In particular, it has been found that the image failure becomes prominent in recent increase in printing speed and size reduction of machines.

### SUMMARY OF THE INVENTION

The present invention has been made in consideration of the above-described problems and situations, and an object to be solved by the present invention is to provide an image forming system and an image forming method in which image failure such as black spots and fogging is suppressed and which are excellent in low-temperature fixing ability and heat resistance.

In order to solve the aforementioned problems, the present inventors have investigated the causes of the aforementioned problems and the like, and as a result, have found that the aforementioned problems can be solved by an image forming system including an electrostatic charge image developing toner containing toner particles containing an amorphous polyester in which the content percentage of a structural unit derived from a bisphenol A derivative is a certain specific value or less, and a developing sleeve having an aluminum alloy containing more than 0.6% by mass of silicon, and have completed the present invention. That is, the abovementioned object according to the present invention is achieved by the following configurations.

According to one aspect of the present disclosure, an image forming system includes: an electrostatic charge image developing toner; and a developing sleeve configured to convey the electrostatic charge image developing toner, wherein, a toner particle included in the electrostatic charge image developing toner contains an amorphous polyester, the amorphous polyester is a polycondensate of a polyvalent carboxylic acid and a polyhydric alcohol, a content percentage of a structural unit derived from a bisphenol A derivative in the amorphous polyester is 10 mol % or less with respect to all structural units derived from the polyhydric alcohol, and the developing sleeve includes an aluminum alloy including more than 0.6% by mass of silicon.

According to another aspect, an image forming method includes: image forming using an electrostatic charge image developing toner and a developing sleeve that conveys the electrostatic charge image developing toner, wherein, a toner particle including the electrostatic charge image developing toner includes an amorphous polyester that is a polycondensate of a polyvalent carboxylic acid and a polyhydric alcohol, a content percentage of a structural unit derived from a bisphenol A derivative in the amorphous polyester is 10 mol % or less with respect to all structural units derived from the polyhydric alcohol, and the developing sleeve includes an aluminum alloy including more than 0.6% by mass of silicon.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is an external view of a developing roller including a developing sleeve;

FIG. 2 is a cross-sectional view of the developing roller in a configuration in which a shaft does not pass through a magnet roller;

FIG. 3 is a cross-sectional view of the developing roller in a configuration in which the shaft passes through the magnet roller;

FIG. 4 is a partial enlarged view of a part of a cross section of the developing sleeve; and

FIG. 5 is an explanatory cross-sectional view showing an example of the configuration of an electrophotographic image forming apparatus.

### DETAILED DESCRIPTION

Hereinafter, one or more embodiments of the present invention will be described with reference to the drawings. However, the scope of the invention is not limited to the disclosed embodiments.

An image forming system according to the present invention includes: an electrostatic charge image developing toner; and a developing sleeve that transports the electrostatic charge image developing toner, wherein toner particles included in the electrostatic charge image developing toner contain an amorphous polyester, the amorphous polyester is a polycondensate of a polyvalent carboxylic acid and a polyhydric alcohol, a content percentage of a structural unit derived from a bisphenol A derivative in the amorphous polyester is 10 mol % or less with respect to all structural units derived from the polyhydric alcohol, and the developing sleeve includes an aluminum alloy containing more than 0.6% by mass of silicon.

This feature is a technical feature common to or corresponding to the following embodiments (aspects).

As an embodiment of the present invention, even when a member that generates a magnetic flux, such as the above-described magnet roller, is provided inside the developing sleeve, it is preferable from the viewpoint that heat generation on the developing sleeve can be suppressed.

The toner particles preferably contain a crystalline resin from the viewpoint of achieving both low-temperature fixability and high-temperature storage stability.

It is preferable that the crystalline resin contains a crystalline polyester, and the crystalline polyester is a polycondensate of an aliphatic dicarboxylic acid having 6 to 14 carbon atoms and an aliphatic diol having 6 to 14 carbon atoms, from the viewpoint of achieving satisfactory low-temperature fixability and satisfactory rising of the charge amount while ensuring heat resistant storage property of the toner.

It is preferable that the polyhydric alcohol contains an aliphatic polyhydric alcohol having 5 or more carbon atoms, from the viewpoint of suppressing the fogging of the toner.

The silicon content in the aluminum alloy is preferably more than 0.8% by mass from the viewpoint of suppressing heat generation on the developing sleeve.

It is preferable that the toner particles contain a release agent having a melting point in a range of 70 to 91° C. from the viewpoints of separation properties from a fixing member, low-temperature fixing performance, and heat resistant storage property of the toner particles.

The toner particles preferably contain silica particles having a mean particle diameter in the range of 90 to 130 nm as an external additive, from the viewpoint of heat resistant storage property.

The image forming method according to the present invention is image forming using an electrostatic charge image developing toner and a developing sleeve that conveys the electrostatic charge image developing toner, wherein toner particles contained in the electrostatic charge image developing toner comprise an amorphous polyester that is a polycondensate of a polyvalent carboxylic acid and a polyhydric alcohol, the content percentage of a structural unit derived from a bisphenol A derivative in the amorphous polyester is 10 mol % or less based on the total structural units derived from the polyhydric alcohol, and the developing sleeve includes an aluminum alloy containing more than 0.6% by mass of silicon, and the image forming method can be suitably used in the image forming system of the present invention.

Hereinafter, the present invention, constituent elements thereof, and forms and aspects for carrying out the present invention will be described in detail. In the present description, when two figures are used to indicate a range of value before and after “to”, these figures are included in the range as a lower limit value and an upper limit value. Note that the advantages and features provided by one or more embodiments of the present invention will be more fully understood from the following detailed description and the accompanying drawings which are given by way of illustration only. Accordingly, it is not intended to define the limits of the present invention.

### Outline of Image Forming System of the Present Invention

### 1. Image Forming System

An image forming system according to the present invention includes: an electrostatic charge image developing toner; and a developing sleeve that transports the electrostatic charge image developing toner, wherein toner particles included in the electrostatic charge image developing toner contain an amorphous polyester, the amorphous polyester is a polycondensate of a polyvalent carboxylic acid and a polyhydric alcohol, a content percentage of a structural unit derived from a bisphenol A derivative in the amorphous polyester is 10 mol % or less with respect to all structural units derived from the polyhydric alcohol, and the developing sleeve includes an aluminum alloy containing more than 0.6% by mass of silicon.

Note that the “image forming system” of the present invention refers to an assembly of devices or apparatuses having predetermined functions, toners or developers, recording media, and the like, which are used as elements necessary for each step of image formation. Then, these as a whole fulfill the function of image formation. The respective elements may be individually arranged at different places apart from each other. Furthermore, the elements may be collectively arranged in a certain space as one device to form a system device.

The image forming system of the present invention may use an image forming apparatus described later as the device or apparatus to form an image. However, as long as the system is in a form or an aspect in which an image is formed using the toner and the developing sleeve, each means constituting the image forming system is not limited.

Further, the image forming system of the present invention may be provided with means for recording and storing the recording and copying information as electronic data, and means for wirelessly communicating the electronic data. For example, a wireless interface for transmitting and receiving data to and from the information processing unit by wireless communication such as Bluetooth (registered trademark) or Wi-Fi (registered trademark) is preferably provided.

As described above, a bisphenol A derivative is often used in production of the amorphous polyester contained in the toner. However, since the bisphenol A derivative has a structure containing a large number of aromatic rings, the molecule is rigid and very difficult to move, and the bisphenol A derivative has a characteristic of inhibiting the meltability of the resin. Therefore, it is required to reduce the amount of the bisphenol A derivative used, but there have been problems that the amount of heat generation increases due to the lowering of the glass transition temperature (Tg), and thus the toner aggregates, and image failure such as black spots occurs.

In the image forming system of the present invention, the developing sleeve having a high surface resistance value is used in combination while the content percentage of the structural unit derived from a bisphenol A derivative is suppressed to be low at the time of image formation. Specifically, when the content percentage of the structural unit derived from the bisphenol A derivative in the amorphous polyester is 10 mol % or less with respect to the total structural units derived from the polyhydric alcohol, the movement of charges in the molecule is facilitated, and the rise of the charge amount is accelerated. In addition, the use of the developing sleeve having a high surface resistance value and including an aluminum alloy containing more than 0.6% by mass of silicon suppresses heat generation during image formation.

From the above, while suppressing adverse effects when the amount of the bisphenol A derivative used is reduced, heat generation on the developing sleeve is suppressed without becoming excessive, and image defects such as black spots can be suppressed.

Hereinafter, constituent elements of the image forming system of the present invention will be sequentially described.

### (1.1) Electrostatic Charge Image Developing Toner

In the present invention, the “electrostatic charge image developing toner” refers to an aggregate of toner particles. Hereinafter, the “electrostatic charge image developing toner” is also referred to simply as the “toner”. The toner particles may be formed of only toner base particles, or may be formed of toner base particles and an external additive to be adhered to surfaces of the toner base particles. The “toner base particles” are base particles of toner particles. The toner base particles contain a binder resin such as amorphous polyester, and may further contain, for example, a coloring agent, a release agent (wax), and a charge control agent, if necessary.

The toner particles included in the electrostatic charge image developing toner according to the present invention contain an amorphous polyester, wherein the amorphous polyester is a polycondensate of a polyvalent carboxylic acid and a polyhydric alcohol, and a content percentage of a structural unit derived from a bisphenol A derivative in the amorphous polyester is 10 mol % or less relative to all structural units derived from the polyhydric alcohol.

### (1.1.1) Amorphous Polyester

From the viewpoint of low-temperature fixability, the toner according to the present invention contains an amorphous polyester. The term “amorphous polyester” refers to a polyester that is amorphous among polyesters obtained by a polymerization reaction of a divalent or higher-valent carboxylic acid (polyvalent carboxylic acid) and a divalent or higher-valent alcohol (polyhydric alcohol). From the viewpoint that bisphenols can be esterified similarly to alcohols, in the present invention, bisphenol A derivatives are included in the “polyhydric alcohol”. Furthermore, the bisphenol A derivative includes bisphenol A itself.

The term “amorphous” means not having a melting point. In other words, the term “amorphous” indicates that the resin does not have a clear endothermic peak during temperature increase in an endothermic curve obtained by differential scanning calorimetry (DSC). The “clear endothermic peak” refers to a peak having a half value width of 15° C. or less in an endothermic curve when the temperature is increased at a temperature increase rate of 10° C./min.

The amorphous polyester according to the present invention is a polycondensate of a polyvalent carboxylic acid and a polyhydric alcohol, and the content percentage of a structural unit derived from a bisphenol A derivative in the amorphous polyester is 10 mol % or less with respect to all structural units derived from the polyhydric alcohol. Also, it is particularly preferably 0 mol %. Thus, toner fog can be further suppressed.

(Content Percentage of Structural Units Derived from Bisphenol a Derivative)

The content percentage of the structural unit derived from a bisphenol A derivative in the amorphous polyester contained in the toner particles can be analyzed by a nuclear magnetic resonance (NMR) apparatus. For example, toner particles to be measured can be dissolved in a deuterium solution and analyzed using a proton nuclear magnetic resonance (1H-NMR) apparatus. Specifically, it is determined by the following method.

First, the toner particles are analyzed together with an internal standard substance having a known concentration. Next, only the component to be analyzed having a known concentration and the internal standard substance are analyzed. Examples of the component to be analyzed having a known concentration include a linear aliphatic diol, etc. By comparing the various spectra obtained by such an analysis, the structural unit derived from a bisphenol A derivative and the total structural unit derived from a polyhydric alcohol in the amorphous polyester can be calculated.

### (Synthesis Method)

The amorphous polyester can be synthesized by esterification through polycondensation of a polyvalent carboxylic acid and a polyhydric alcohol with the use of a known esterification catalyst.

### [Polyhydric Alcohol]

Examples of polyhydric alcohols other than bisphenol A derivatives that can be used for synthesis of the amorphous polyester include, as dihydric or trihydric alcohols, ethyleneglycol, propyleneglycol, 1,4-butanediol, 2,3-butanediol, diethylene glycol, triethylene glycol, 1,5-pentanediol, 1,6-hexanediol, neopentyl glycol, 1,4-cyclohexanedimethanol, dipropylene glycol, polyethylene glycol, polypropylene glycol, glycerin, sorbitol, 1,4-sorbitan, and trimethylolpropane.

The bisphenol A derivatives include bisphenol A and derivatives thereof. Examples of the bisphenol A derivative include bisphenol A, an ethylene oxide adduct of bisphenol A, and a propylene oxide adduct of bisphenol A.

From the viewpoint of low-temperature fixing ability, it is preferable to include an aliphatic polyhydric alcohol. Since the molecules are easy to move, the low-temperature fixability is improved. The polyhydric alcohol component is preferably any of ethylene glycol, neopentyl glycol, propane glycol, and 1,5-pentanediol. In addition, the polyhydric alcohol preferably contains an aliphatic polyhydric alcohol having 5 or more carbon atoms from the viewpoint of suppressing fogging of the toner.

Since the structural unit derived from the aliphatic polyhydric alcohol having 5 or more carbon atoms included in the amorphous polyester has a large degree of freedom of molecular motion, the charge transfer in the molecule of the amorphous polyester is facilitated by including the structural unit. Therefore, when the amorphous polyester has a structural unit derived from an aliphatic polyhydric alcohol having 5 or more carbon atoms, toner fog can be further suppressed.

In the synthesis of the amorphous polyester according to the present invention, an aliphatic polyhydric alcohol having 5 or more carbon atoms is preferably used. As the aliphatic polyhydric alcohol having 5 or more carbon atoms, neopentyl glycol is particularly preferable.

### [Polyvalent Carboxylic Acid]

Examples of polyvalent carboxylic acids that can be used in the synthesis of the amorphous polyester include phthalic acids, isophthalic acids, terephthalic acids, trimellitic acids, naphthalene 2,6-dicarboxylic acids, malonic acids, mesaconic acids, dimethyl isophthalate, fumaric acids, dodecenyl succinic acids, and 1-,-10-dodecane dicarboxylic acids. Among these, terephthalic acid, fumaric acid, and dodecenyl succinic acid are preferable.

### [Catalyst]

Examples of catalysts that can be used in the synthesis of the amorphous polyester include metal-containing compounds, phosphite compounds, phosphate compounds, and amine compounds.

Examples of the metal contained in the metal-containing compound include sodium, lithium, magnesium, calcium, aluminum, zinc, manganese, antimony, titanium, tin, zirconium, and germanium. These may be used alone or in combination of two or more kinds thereof.

Specific examples of the tin-containing compound include dibutyltin oxide, tin octylate, tin dioctylate, and salts thereof.

Examples of the titanium-containing compound include titanium alkoxide, titanium acylate, and titanium chelate. Examples of the titanium alkoxide include Ti (O-n-Bu) 4(tetra-n-butyl titanate), tetraisopropyl titanate, tetramethyl titanate, and tetrastearyl titanate. Examples of the titanium acylate include polyhydroxy titanium stearate. Examples of the titanium chelate include titanium tetraacetylacetonate, titanium lactate, and titanium triethanolaminate.

An example of the germanium-containing compound includes germanium dioxide.

Examples of the aluminum-containing compound include polyaluminum hydroxide, aluminum alkoxide, and tributyl aluminate.

### (Polymerization Temperature)

The polymerization temperature is not particularly limited, but is preferably in a range of 150 to 250° C. The polymerization time is not particularly limited, but is preferably in a range of 0.5 to 10 hours. During the polymerization of the compound, the pressure in the reaction system may be reduced as necessary.

### (Glass Transition Temperature and Weight Mean Molecular Weight)

The glass transition point (Tg) of the amorphous polyester is preferably in a range of 25 to 60° C., and more preferably in a range of 35 to 55° C., from the viewpoint of achieving both sufficient low-temperature fixability and heat resistant storage property. The glass transition point (Tg) can be measured using a differential scanning calorimeter, for example, Diamond DSC (manufactured by PerkinElmer, Inc.).

The weight mean molecular weight (Mw) of the amorphous polyester may be in the range of 10,000 to 100,000. The weight mean molecular weight (Mw) can be measured by gel permeation chromatography (GPC).

### (Others)

The amorphous polyester may be a hybrid amorphous polyester having a graft copolymer structure of an amorphous polyester polymerized segment and a styrene-acrylic polymerized segment.

The content of the amorphous polyester is preferably in the range of 50 to 100% by mass and more preferably in the range of 70 to 90% by mass relative to the total amount of the resins contained in the toner base particles.

### (1.1.2) Crystalline Resin

The toner particles according to the present invention preferably contain a crystalline resin from the viewpoint of achieving both low-temperature fixing ability and high-temperature storage stability. From the viewpoint of low-temperature fixability, the crystalline resin is more preferably a crystalline polyester.

The term “crystalline” means having a melting point. In other words, the term “crystalline” refers to having a clear endothermic peak during temperature increase in an endothermic curve obtained by differential scanning calorimetry (DSC). The “clear endothermic peak” refers to a peak having a half value width of 15° C. or less in an endothermic curve when the temperature is increased at a temperature increase rate of 10° C./min.

The melting point (Tm) of the crystalline resin is more preferably within a range of 62 to 82° C. from the viewpoint of obtaining sufficient low-temperature fixing ability and high-temperature storage stability.

The crystalline resin contained in the toner particles is not particularly limited, and examples thereof include polyolefin-based resins, polydiene-based resins, and polyester-based resins. Among these, the crystalline resin contained in the toner particles is more preferably a crystalline polyester. Thus, while the heat resistant storage property of the toner is ensured, the low-temperature fixability can be improved, and furthermore, the rise of the charge amount can also be improved.

### (Crystalline Polyester)

The crystalline polyester is a polyester that exhibits crystallinity among polyesters obtained by a polymerization reaction of a divalent or higher-valent carboxylic acid (polyvalent carboxylic acid) and a divalent or higher-valent alcohol (polyhydric alcohol). The crystalline polyester can be produced by esterification through polycondensation of a polyvalent carboxylic acid and a polyhydric alcohol using a known esterification catalyst.

### [Polyvalent Carboxylic Acid]

Examples of divalent polyvalent carboxylic acids that can be used in the synthesis of the crystalline polyester include saturated aliphatic dicarboxylic acids, unsaturated aliphatic dicarboxylic acids, and unsaturated aromatic dicarboxylic acids. Examples of saturated aliphatic dicarboxylic acids include oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid (dodecanedioic acid), 1,11-undecanedicarboxylic acid, 1,12-dodecanedicarboxylic acid, 1,13-tridecanedicarboxylic acid, 1,14-tetradecanedicarboxylic acid, 1,16-hexadecanedicarboxylic acid, and 1,18-octadecanedicarboxylic acid and the like. Examples of the unsaturated aliphatic dicarboxylic acid include methylenesuccinic acid, fumaric acid, maleic acid, 3-hexenedioic acid, 3-octenedioic acid, and dodecenylsuccinic acid. Examples of the unsaturated aromatic dicarboxylic acids include phthalic, terephthalic, isophthalic, t-butylisophthalic, tetrachlorophthalic, chlorophthalic, nitrophthalic, p-phenylenediacetic, 2,6-naphthalenedicarboxylic, 4,4′-biphenyldicarboxylic, and anthracenedicarboxylic acids, and the like. Lower alkyl esters and acid anhydrides of these dicarboxylic acids can also be used as the polyvalent carboxylic acid.

Examples of the trivalent or higher polyvalent carboxylic acid that can be used in the synthesis of the crystalline polyester include trimellitic acid and pyromellitic acid.

### [Polyhydric Alcohol]

Examples of dihydric polyhydric alcohols usable for synthesis of the crystalline polyester include saturated aliphatic diols, unsaturated aliphatic diols, and aromatic diols.

Examples of saturated aliphatic diols include ethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,20-eicosanediol, neopentyl glycol, and the like.

Examples of the unsaturated aliphatic diol include 2-butene-1,4-diol, 3-butene-1,4-diol, 2-butyne-1,4-diol, 3-butyne-1,4-diol, and 9-octadecene-7,12-diol.

Examples of the aromatic diol include bisphenols and alkylene oxide adducts of bisphenols. Examples of the bisphenols include bisphenol A and bisphenol F. Examples of the alkylene oxide adducts of bisphenols include ethylene oxide adducts of bisphenols and propylene oxide adducts of bisphenols. Derivatives of these diols can also be used as the polyhydric alcohol.

The crystalline polyester according to the present invention is preferably a polycondensate of an aliphatic dicarboxylic acid having 6 to 14 carbon atoms and an aliphatic diol having 6 to 14 carbon atoms, from the viewpoint of improving the low-temperature fixability and the rising of the charge amount while ensuring the heat resistant storage property of the toner.

When the structural unit of the crystalline polyester is an ester, the number of carbon atoms including the ester moiety is preferably 6 to 14 from the viewpoint of improving the low-temperature fixability and the rise of the charge amount while ensuring the heat resistant storage property of the toner.

The smaller the number of carbon atoms of the acid and alcohol constituting the crystalline polyester, the more easily the toner particles containing the resin melt, and the better the low-temperature fixability. On the other hand, when the toner particles are too easily melted, the heat resistance is lowered, and for example, in a case where the toner particles are stored in a developing device in a heated state, the toner particles are aggregated in some cases.

Therefore, when the acid and the alcohol constituting the crystalline polyester each have 6 to 14 carbon atoms, the toner can have satisfactory low-temperature fixability while ensuring heat resistant storage property.

In addition, when the number of carbon atoms of the acid and the alcohol constituting the crystalline polyester increases, the polarity of the crystalline polyester decreases, and the crystalline polyester becomes less compatible with other resins. Therefore, as the number of carbon atoms in the acid and the alcohol that form the crystalline polyester increases, the size of the domains of the crystalline polyester in the binder resin increases. On the other hand, as the number of carbon atoms in the acid and alcohol constituting the crystalline polyester decreases, the polarity of the crystalline polyester increases, making the crystalline polyester more compatible with other resins. Therefore, when the carbon numbers of the acid and the alcohol constituting the crystalline polyester are decreased, the crystalline polyester is finely dispersed in the binder resin.

When the dispersion state of the crystalline polyester is appropriate, the distance between domains of the crystalline polyester becomes short. Thus, in the toner particles, resistance to charge transfer decreases, making it easier for the charge amount to rise. Therefore, also from the viewpoint of a dispersion state that improves the rise of the charge amount, the number of carbon atoms of each of the acid and the alcohol constituting the crystalline polyester is preferably in the range of 6 to 14.

For synthesis of the crystalline polyester, any of the catalysts usable for synthesis of the amorphous polyester described above can be used.

The polymerization temperature is not particularly limited, but is preferably in a range of 70 to 250° C. The polymerization time is not particularly limited, but is preferably in a range of 0.5 to 10 hours. During the polymerization, the pressure in the reaction system may be reduced as necessary.

The crystalline polyester may be a hybrid crystalline polyester having a graft copolymer structure of a crystalline polyester polymerized segment and a styrene-acrylic polymerized segment.

The weight mean molecular weight Mw of the crystalline polyester is preferably within a range of 1000 to 29000. The weight mean molecular weight Mw can be measured by gel permeation chromatography (GPC).

The content of the crystalline polyester is preferably in a range of 5 to 30% by mass and more preferably in a range of 10 to 20% by mass with respect to the total amount of resins contained in the toner base particles.

### (1.1.3) Vinyl-Based Resin

The toner particle according to the present invention may contain a vinyl-based resin. The vinyl-based resin refers to a polymer of a monomer having a vinyl group, which is amorphous. Hereinafter, the “monomer having a vinyl group” is also simply referred to as a “vinyl monomer”. Examples of the vinyl-based resin that can be used include a styrene-acrylic resin, a styrene resin, and an acrylic resin, and among these, a styrene-acrylic resin excellent in heat resistance is preferable. Examples of the vinyl monomer that can be used include the following monomers (1) to (7), and among these, one type can be used alone, or two or more types can be used in combination.

### (1) Styrene-Based Monomer

Examples thereof include monomers having a styrene structure, such as styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, p-n-dodecylstyrene, and derivatives thereof.

### (2) (Meth) Acrylic Acid Ester Monomer

Examples thereof include monomers having a (meth) acrylic group, such as methyl (meth) acrylate, ethyl (meth) acrylate, n-butyl (meth) acrylate, isopropyl (meth) acrylate, isobutyl (meth) acrylate, t-butyl (meth) acrylate, n-octyl (meth) acrylate, 2-ethylhexyl (meth) acrylate, stearyl (meth) acrylate, lauryl (meth) acrylate, phenyl (meth) acrylate, diethylaminoethyl (meth) acrylate, dimethylaminoethyl (meth) acrylate, and derivatives thereof.

(3) Vinyl esters
vinyl propionate, vinyl acetate, vinyl benzoate, and the like
   (4) Vinyl ethers
vinyl methyl ether, vinyl ethyl ether, etc
   (5) Vinyl ketones
vinyl methyl ketone, vinyl ethyl ketone, vinyl hexyl ketone, etc
   (6) N-vinyl compounds
N-vinylcarbazole, N-vinylindole, N-vinylpyrrolidone, and the like

### (7) Others

Examples thereof include vinyl compounds such as vinylnaphthalene and vinylpyridine, and acrylic acid and methacrylic acid derivatives such as acrylonitrile, methacrylonitrile, and acrylamide.

The vinyl monomer is preferably a monomer having an ionic dissociable group such as a carboxy group, a sulfonic acid group, or a phosphoric acid group. When the vinyl monomer is any of these monomers, the affinity with the crystalline resin can be easily controlled.

Examples of the monomer having a carboxy group include acrylic acid, methacrylic acid, maleic acid, itaconic acid, cinnamic acid, fumaric acid, maleic acid monoalkyl ester, and itaconic acid monoalkyl ester.

Examples of the monomer having a sulfonic acid group include styrenesulfonic acid, allylsulfosuccinic acid, and 2-acrylamido-2-methylpropanesulfonic acid.

Examples of the monomer having a phosphate group include acidophosphooxyethyl methacrylate.

A polymer having a crosslinked structure can also be obtained by using polyfunctional vinyls as the vinyl monomer. Examples of the polyfunctional vinyls include divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate, and neopentyl glycol diacrylate.

### (1.1.4) Release Agent

The toner particle according to the present invention preferably contains a release agent. The release agent is not particularly limited, and various known waxes can be used.

Examples of the release agent that can be used include branched-chain hydrocarbon waxes, long-chain hydrocarbon-based waxes, dialkyl ketone-based waxes, ester-based waxes, and amide-based waxes. Examples of the branched chain hydrocarbon wax include polyolefin waxes such as polyethylene wax and polypropylene wax, and microcrystalline waxes. Examples of the long-chain hydrocarbon-based wax include paraffin wax and Sasol wax. Examples of the dialkyl ketone-based wax include distearyl ketone. Examples of the ester-based wax include carnauba wax, montan wax, behenyl behenate, trimethylolpropane tribehenate, pentaerythritol tetrabehenate, pentaerythritol diacetate dibehenate, glycerin tribehenate, 1,18-octadecanediol distearate, tristearyl trimellitate, distearyl maleate, and stearyl stearate. Examples of the amide-based wax include ethylenediamine behenylamide and trimellitic acid tristearylamide.

Examples of commercially available products of the release agent include HNP-0190, HNP-51, and FNP-0090 manufactured by Nippon Seiro Co., Ltd, and C80 manufactured by Sasol Ltd. These release agents may be used alone or in combination of two or more kinds thereof.

The content of the release agent can be usually within a range of 1 to 30% by mass, and is preferably within a range of 5 to 20% by mass, relative to the total amount of the resin contained in the toner base particles. When the content of the release agent is within the above range, sufficient fixing separability can be obtained.

### (Melting Point of Release Agent)

It is preferable that the toner particles contain a release agent having a melting point in a range of 70 to 91° C. from the viewpoints of separation properties from a fixing member, low-temperature fixing performance, and heat resistant storage property of the toner particles. When the melting point (Tm) is 91° C. or less, the release agent easily exudes from the toner particles at the time of fixing, and the amount of the release agent on the surface of the image increases. Thus, the separability from the fixing member is improved, and the low-temperature fixability is improved. In addition, when the melting point (Tm) is 70° C. or more, the release agent is unlikely to be disposed on the surface of the toner particles during production due to a difference in viscosity between the release agent and the binder resin, and thus the heat resistant storage property of the toner particles is improved.

The melting point (Tm) of the release agent can be measured and obtained by differential scanning calorimetry (DSC). For example, the procedure is as follows. A differential scanning calorimeter “DSC7000X” (manufactured by Hitachi, Ltd) and a thermal analyzer controller “AS3/DX” (manufactured by Hitachi, Ltd) are used. The measurement sample 0.5 mg is placed in an AI autosampler sample vessel φ6.8 H2. 5 mm (manufactured by Hitachi, Ltd). This is sealed using an AI autosampler cover (manufactured by Hitachi, Ltd). This is set in a sample holder of “AS3/DX”.

The measurement conditions are a measurement temperature of 0 to 200° C., a temperature increase rate of 10° C./min, and a temperature decrease rate of 10° C./min. Temperature control of the Heat-cool-Heat is performed and the data in 1 st Heat is analyzed. An empty aluminum pan is used for the reference measurement.

The peak top temperature of the endotherm peak derived from the crystalline resin in 1 st. Heat is defined as the melting point (Tm). In a case where a plurality of endothermic peaks is detected, the peak top temperature of the peak on the highest temperature side among the endothermic peaks is defined as the melting point (Tm) of the release agent.

### (1.1.5) Coloring Agent

The toner particle according to the present invention may contain a coloring agent. As the coloring agent, a known inorganic coloring agent or organic coloring agent can be used. As the coloring agent, carbon black, magnetic powder, an organic pigment, an inorganic pigment, a dye, or the like can be used. The content of the coloring agent is preferably from 1 to 30% by mass, more preferably from 2 to 20% by mass, relative to the toner particles.

### (1.1.6) Charge Control Agent

The toner particles according to the present invention may contain a charge control agent. As the charge control agent, for example, known compounds such as nigrosine dyes, metal salts of naphthenic acid, metal salts of higher fatty acids, alkoxylated amines, quaternary ammonium salts, azo metal complexes, and metal salts of salicylic acid can be used. By using the charge control agent, a toner having excellent chargeability can be obtained. The content of the charge control agent can be usually within a range of 0.1 to 5.0% by mass with respect to the total amount of the resin contained in the toner base particles.

### (1.1.7) External Additives

The toner particle according to the present invention preferably includes an external additive. Examples of the external additive include inorganic oxide fine particles, inorganic stearic acid compound fine particles, inorganic titanic acid compound fine particles, and zirconia particles. These external additives may be used alone or in combination with two or more types.

Examples of the inorganic oxide fine particles include silica particles, alumina fine particles, titanium oxide fine particles, zinc oxide particles, chromium oxide particles, cerium oxide particles, antimony oxide particles, tungsten oxide particles, tin oxide particles, tellurium oxide particles, manganese oxide particles, and boron oxide particles. Examples of the inorganic stearic acid compound fine particles include aluminum stearate fine particles and zinc stearate fine particles. Examples of the inorganic titanate compound fine particles include strontium titanate and zinc titanate.

The amount of the external additive to be added is preferably in a range of 0.05 to 5% by mass, more preferably in a range of 0.1 to 3% by mass relative to the total amount of the toner base particles. When a plurality of external additives are used, the addition amount is the total addition amount thereof. Among these, the toner particles according to the present invention preferably have silica particles or strontium titanate particles as the external additive.

### (Silica Particles)

The silica particles are particles containing silica (SiO 2) as a main component. The silica particles may be either crystalline or amorphous. The silica particles may be particles produced using, as a raw material, a silicon compound such as water glass or alkoxysilane, or particles obtained by grinding quartz.

The silica particles may be, for example, sol-gel silica particles, aqueous colloidal silica particles, alcoholic silica particles, fumed silica particles obtained by a gas-phase method or the like, and fused silica particles. Of the foregoing, the silica particles are preferably sol-gel silica particles.

The sol-gel silica particles are obtained, for example, as follows. Tetraalkoxysilane (TMOS or the like) is added dropwise to an alkali catalyst solution containing an alcohol compound and ammonia water, and the tetraalkoxysilane is hydrolyzed and condensed to obtain a suspension containing sol-gel silica particles. Next, the solvent is removed from the suspension to obtain a granular material. Next, the granular material is dried, thereby obtaining sol-gel silica particles.

The silica particles may be silica particles hydrophobized with a hydrophobizing agent. Examples of the hydrophobizing agent include known organic silicon compounds having an alkyl group (for example, a methyl group, an ethyl group, a propyl group, or a butyl group). Specific examples of the hydrophobizing agent include an alkoxysilane compound, a siloxane compound, and a silazane compound. Of the foregoing, the hydrophobizing agent is preferably at least one of a siloxane compound and a silazane compound. Examples of the siloxane compound include a silicone oil and a silicone resin. The silicone oil is preferably dimethyl silicone oil. Examples of the silazane compound include hexamethyldisilazane and tetramethyldisilazane. The silazane compound is preferably hexamethyldisilazane (HMDS). The hydrophobizing agents can be used alone or in combination of two or more kinds thereof.

The amount of the hydrophobizing agent, such as a silazane compound, adhered to the surface of the silica particles is preferably in a range of 0.01 to 5% by mass relative to the silica particles from the viewpoint of improving the degree of hydrophobization of the silica particles. The surface deposition amount is more preferably in a range of 0.05 to 3% by mass, and still more preferably in a range of 0.10 to 2% by mass.

Examples of the method of subjecting the silica particles to the hydrophobic treatment with the hydrophobic treatment agent include the following methods.
[1] A method in which a hydrophobizing agent is dissolved in supercritical carbon dioxide and the solution is applied to the surface of the silica particle.
[2] A method in which a solution containing a hydrophobizing agent is applied to the surfaces of the silica particles in the air. Examples of the application method include a spraying method and a coating method.
[3] A method in which a solution containing a hydrophobizing agent is added to a silica particle dispersion liquid in the atmosphere and held, and then the mixed liquid is dried.

The number mean particle diameter of the silica particles is preferably within a range of 90 to 130 nm from the viewpoint of heat resistant storage property. When the number mean particle diameter of the silica particles is 90 nm or more, the silica particles tend to exhibit a spacer effect with other toner particles. Thus, even when the toner base particles have high meltability, the toner particles are unlikely to coalesce and aggregate with each other and the heat resistant storage property is improved. When the number mean particle diameter of the silica particles is 130 nm or less, the silica particles are less likely to be detached from the toner base particles, and thus a decrease in heat resistant storage property due to exposure of the toner base particles can be suppressed.

The number mean particle diameter of the silica particles is determined by the following procedure.
(1) The toner particles are dispersed in methanol, and the mixture is stirred at room temperature (23° C.) and treated in an ultrasonic bath to separate the external additive from the toner base particles. The toner base particles are precipitated by centrifugation, and a dispersion liquid in which the external additive is dispersed is collected. The methanol is distilled off from the dispersion liquid, and the external additive is removed.
(2) The external additive taken out is dispersed in resin particles (polyester, weight mean molecular weight Mw=50000) having a volume mean particle diameter of 100 μm.
(3) An image of the resin particles in which the external additive is dispersed is captured at a magnification of 40,000 times using a scanning electron microscope equipped with an energy dispersive X-ray analyzer. At this time, 300 or more primary particles of silica are specified from one visual field based on the presence of Si by EDX analysis. The SEM observation is performed with an acceleration voltage of 15 kV and an emission current of 20 μA at WD15 mm. The EDX analysis is performed under the same conditions for a detection time of 60 minutes. Examples of the energy dispersive X-ray analyzer include an EDX apparatus “EMAX Evolution X-Max 80 mm2” manufactured by Horiba, Ltd. The above-described “EDX” analysis refers to analysis by this EDX apparatus. An example of the scanning electron microscope includes SEM “S-4800” manufactured by Hitachi High-Tech Corporation.
(4) The obtained image is loaded into an image analyzing apparatus “LUZEXIII” manufactured by Nireco Corporation. The area of each particle is obtained by analyzing the captured image.
(5) From the measured area value, the particle diameter of the silica particles is determined as a circle-equivalent diameter.
(6) 100 silica particles having equivalent circle diameters of 80 nm or more are selected.
(7) The number mean particle diameter is calculated from the particle diameters of the selected silica particles.

### (Strontium Titanate Particle)

The strontium titanate particles are particles containing strontium titanate (SrTiO3) as a main component. The strontium titanate particles are positively charged. Therefore, when the strontium titanate particle is included as the external additive, the strontium titanate particle can promote negative charging of the toner base particles to suppress fogging.

The number mean primary particle diameter of the strontium titanate particles is preferably in a range of 30 to 100 nm, more preferably in a range of 30 to 80 nm, and still more preferably in a range of 30 to 60 nm. When the number mean primary particle diameter of the strontium titanate particles is 30 nm or more, the embedding of the strontium titanate particles in the toner base particles is suppressed. When the number mean primary particle diameter of the strontium titanate particles is equal to or less than 100 nm, it is easy to increase the surface-coating amount with respect to the toner base particles.

The number mean primary particle diameter of the strontium titanate particles can be measured in the same manner as the number mean particle diameter of the silica particles described above. Note that in the EDX analysis, 300 or more primary particles of strontium titanate are specified from one visual field on the basis of the presence of Ti and Sr.

The strontium titanate particle preferably has a rounded shape. For example, the mean circularity of the strontium titanate particles is preferably in a range of 0.82 to 0.94, more preferably in a range of 0.84 to 0.94, and still more preferably in a range of 0.86 to 0.92. When the mean circularity of the strontium titanate particles is 0.82 or more, the dispersibility thereof in the toner base particles is easily increased. When the mean circularity of the strontium titanate particles is 0.94 or less, the mobility of the strontium titanate particles on the surface of the toner base particles decreases, and the uniform dispersibility of the surface is easily enhanced.

### (1.1.8) Method for Producing Toner

The toner can be produced by producing toner base particles and adding an external additive thereto as necessary. Examples of the method for producing the toner base particles include a kneading and pulverizing method, a suspension polymerization method, an emulsion aggregation method, a dissolution suspension method, a polyester elongation method, and a dispersion polymerization method. Among these, the emulsion aggregation method is preferable from the viewpoint of uniformity of particle size, controllability of shape, easiness of formation of a core-shell structure, and the like, which are advantageous for high image quality and high stability.

The emulsion aggregation method is performed, for example, by the following procedure. A dispersion liquid in which resin particles are dispersed with a surfactant or a dispersion stabilizer is mixed with a dispersion liquid of coloring agent particles or the like. An aggregating agent is added to this system, and aggregation is performed until a desired particle diameter is obtained. Thereafter or simultaneously with the aggregation, fusion between the resin particles is performed to control the shape, thereby producing toner base particles.

The resin particles may contain an internal additive such as a release agent or a charge control agent. The resin particles may be composite particles formed of two or more layers composed of resins having different compositions.

It is also preferable to add different types of resin particles at the time of aggregation to form toner base particles having a core-shell structure, from the viewpoint of toner structure design.

The resin particles can be produced by, for example, an emulsion polymerization method, a mini-emulsion polymerization method, or a phase inversion emulsification method. In a case where the internal additive is contained in the resin particles, the resin particles are preferably produced by a mini-emulsion polymerization method.

In the drying step of the toner base particles, drying conditions are adjusted, if necessary, in order that the toner particles have a water content as described above. For example, the drying conditions are adjusted so that the toner base particles are not excessively dried, in other words, so that a certain amount of moisture remains in the toner base particles.

The method for drying the toner base particles is not particularly limited, but from the viewpoint of productivity, freeze drying, flash jet drying, vibration-type fluidized drying, or the like is preferable. Among these, flash jet drying is more preferable. Conditions for preventing the toner base particles from being overdried in the flash jet drying include, for example, the following methods.
[1] The temperature of the blown gas (inlet temperature) is increased.
[2] The temperature (outlet temperature) of the gas to be discharged is lowered.
[3] Both temperatures are lowered without changing the temperature difference between the blown gas and the discharged gas.
[4] Increase the blown air volume.

Preferable examples of the method for adding the external additive to the toner base particles include a dry method in which the external additive is added in the form of powder to the dried toner base particles. Examples of the mixing apparatus include mechanical mixing apparatuses such as a Henschel mixer and a coffee mill.

### (1.1.9) Developer

The toner according to the present invention may be used alone as a magnetic or non-magnetic mono-component developer, or may be mixed with carrier particles and used as a two-component developer. As the carrier particles, for example, magnetic particles formed of a conventionally known material can be used. Examples of the magnetic particles include metals such as iron, ferrite, and magnetic, and alloys of these metals and metals such as aluminum and lead. In particular, ferrite particles are preferable as the carrier particles.

As the carrier particles, coated carrier particles in which the surface of magnetic particles is coated with a coating agent such as a resin, or dispersed carrier particles in which a magnetic fine powder is dispersed in a binder resin may be used. The carrier particles are preferably coated carrier particles from the viewpoint of suppressing adhesion of the carrier particles to the photoreceptor.

The volume-based median diameter of the carrier particles is preferably within a range of 20 to 100 μm, and more preferably within a range of 25 to 80 μm. The volume-based median diameter of the carrier particles can be measured with, for example, a laser diffraction particle size distribution analyzer (HELOS, SYMPATEC GmbH) equipped with a wet disperser.

An appropriate amount of the carrier particles may be mixed with the above-described toner particles. Examples of the mixing apparatus to be used for the mixing include a Nauta mixer, a W-shape rotating mixer and a V-shape rotating mixer.

### (1.2) Developing Sleeve

The developing sleeve according to the present invention has a role of conveying the developer containing toner and carrier. The developing sleeve includes an aluminum alloy containing more than 0.6% by mass of silicon. The developing sleeve is included in a developing roller.

The “developing sleeve” according to the present invention is means having a function of bearing a moderately charged developer and supplying the developer to a photoreceptor on which an electrostatic charge image has been formed. The developing sleeve is, for example, a part of a developing roller included in a developing device included in an electrophotographic image forming apparatus, and the developing roller includes a developing sleeve, a flange, a shaft, and a magnet roller. However, the developing roller including the developing sleeve of the present invention as a part of the constitution thereof may not include a magnet portion such as a magnet roller as a part of the constitution thereof.

According to the present invention, even when a member that generates a magnetic flux, such as the above-described magnet roller, is provided inside the developing sleeve, heat generation on the developing sleeve can be suppressed.

The aluminum alloy is a conductive material having a relatively low electrical resistance, and when the developing sleeve is rotated relative to the magnet roller, the developing sleeve crosses magnetic lines of force generated from the magnet roller. Thus, an electromagnetic induction action occurs, and heat is generated due to an eddy current in the vicinity of the surface of the developing sleeve. In a case where the current density of the eddy current is high, the heat generation increases, and thus the toner and the carrier are thermally fused and aggregated, with the result that the aggregate causes image failure such as black spots.

In particular, due to recent demands for higher printing speed, size reduction of machines, and the like, the developing sleeve is required to have a small diameter. Furthermore, the developing sleeve is also required to rotate at high speed while maintaining a high magnetic flux density. Thus, heat generation of the developing sleeve due to the eddy current is further increased. Therefore, image failure such as black spots becomes more prominent.

In the present invention, the aluminum alloy contained in the developing sleeve contains more than 0.6% by mass of silicon, whereby the resistance value of the surface of the developing sleeve is increased. In addition, since silicon has substantially the same chargeability as aluminum, silicon does not hamper the chargeability between toner carriers. Therefore, appropriate chargeability can be maintained during image formation. As a result, even when a member for generating a magnetic flux is provided inside the developing sleeve, generation of an eddy current is suppressed, and heat generation can be suppressed. Therefore, it is presumed that even when the content percentage of the structural unit derived from a bisphenol A derivative in the amorphous polyester contained in the toner particles included in the electrostatic charge image developing toner used in image formation is low, occurrence of image failure such as black spots can be suppressed.

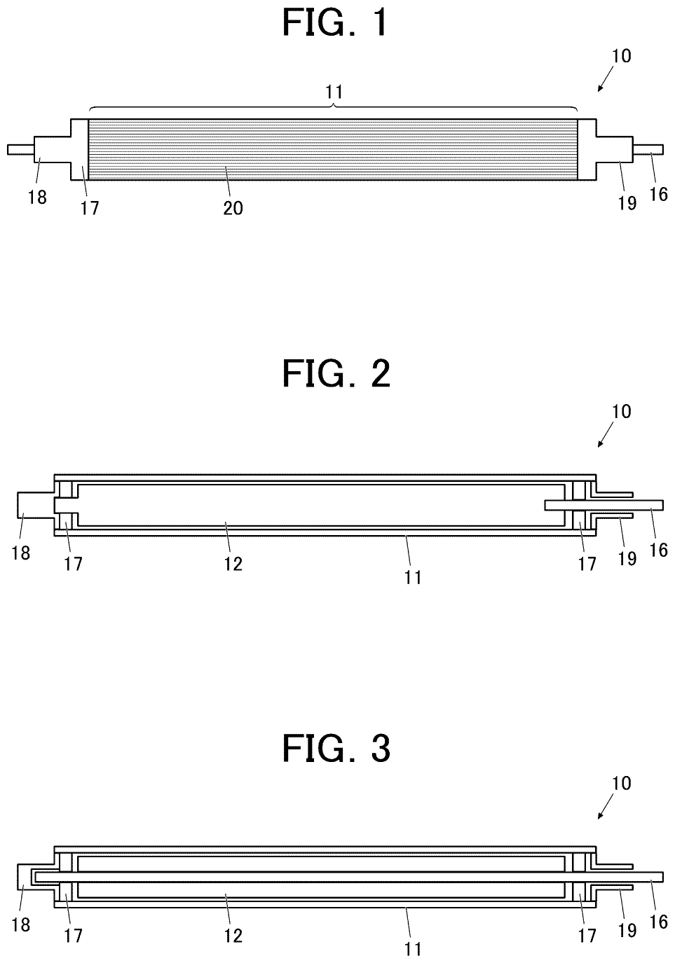

FIG. 1 is an external view of a developing roller including a developing sleeve. The developing sleeve is rotatable and cylindrical, and plays a role of carrying and conveying the developer on its surface. As shown in FIG. 1, on the surface of a developing sleeve 11, a plurality of grooves 20 extending in the axial direction of the developing roller 10 are formed at predetermined intervals in the circumferential direction. The surface of the developing sleeve of the present invention may not have the above-described grooves.

Further, FIG. 2 and FIG. 3 are axial cross-sectional views of developing rollers which are an example of the developing sleeve of the present invention and which include magnet rollers and shafts having different shapes. However, the developing roller including the developing sleeve of the present invention as a part of the constitution thereof may not include a magnet portion such as a magnet roller as a part of the constitution thereof. The configuration is not limited to the configuration shown in FIG. 2 and FIG. 3.

Note that FIG. 2 is a cross-sectional view of a developing roller having a configuration in which a shaft does not penetrate a magnet roller. As illustrated in FIG. 2, the developing roller 10 fixes a shaft 16 by inserting the shaft into a hole formed in the magnet roller 12, and includes the developing sleeve 11 of a non-magnetic material on an outer periphery of the magnet roller 12.

FIG. 3 is a cross-sectional view of a developing roller having a configuration in which a shaft extends through a magnet roller. As illustrated in FIG. 3, the developing roller 10 includes the magnet roller 12 fixed around the shaft 16, and the developing sleeve 11 that is made of a non-magnetic material and is provided on an outer periphery of the magnet roller 12.

The developing sleeve 11 is connected to the magnet roller 12 with a predetermined gap therebetween via a bearing part 17, such as a bearing, provided outside the magnet roller 12. On the outside of the bearing part 17 in the axial direction of the developing sleeve 11, a non-driving side flange 18 and a driving side flange 19 are connected to the developing sleeve 11. The non-driving side flange 18 and the driving side flange 19 may be reversed, and the present invention is not limited thereto. The non-driving side flange 18 and the driving side flange 19 are rotationally driven together with the developing sleeve 11 while being held with respect to the developing container.

### (1.2.1) Silicon Content in Aluminum Alloy

From the viewpoint of suppressing heat generation on the developing sleeve, the silicon content is preferably more than 0.8% by mass, and more preferably 1.4% by mass or more. In addition, when the silicon content is too large, the non-uniformity of the surface of the developing sleeve is increased, and the charging leakage is liable to occur, and therefore, the silicon content is preferably 4.4% by mass or less.

Note that the aluminum alloy of the developing sleeve according to the present invention does not include materials forming the above-described flange, shaft, and magnet roller. See FIGS. 1, 2, and 3.

### (1.2.2) Surface Condition of Developing Sleeve

The developing sleeve according to the present invention has a role of conveying the developer containing toner and carrier. Therefore, by providing appropriate surface roughness to the surface, the developer transportability is improved and maintained.

The method for providing the surface of the developing sleeve according to the present invention with appropriate roughness is not particularly limited, but the surface of the developing sleeve is preferably subjected to sand blasting from the viewpoint of improving the transportability of the developer. The sandblast treatment forms irregularities on the surface of the developing sleeve, so that the roughness of the outer peripheral surface can be appropriately maintained and excellent transportability can be ensured.

When silicon is contained in the developing sleeve, the surface of the developing sleeve is abraded differently between a portion containing the silicon and a portion not containing the silicon at the time of sandblasting, and therefore, appropriate surface roughness can be applied to the surface of the developing sleeve.

The sandblast processing is a process of forming an uneven shape by projecting a blast material onto the surface of the developing sleeve and denting the surface in a concave shape with the blast material. Examples of the sandblasting processing include air blasting processing, wet sandblasting processing, and shot blasting processing.

The material applicable to the sandblasting processing is not particularly limited, and a known material can be appropriately used. Specifically, glass beads, alumina particles, silica particles, titania particles, zirconia particles, and the like can be used. As the material, organic fine particles can also be used. Examples of the organic particles include melamine resin particles, benzoguanamine resin particles, and crosslinked acrylic resin particles.

As a material applicable to the sandblasting, in particular, spherical glass beads or alumina beads are preferable from the viewpoint of applying such an impact force as to recess the elastic layer but not tear the surface layer surface. These materials may be used alone or in combination of two or more kinds thereof.

The volume mean particle diameter of the above-described material is preferably in a range of 3 to 200 μm, more preferably in a range of 10 to 100 μm, and still more preferably in a range of 20 to 80 μm, although it varies depending on the size of the targeted irregularities on the surface of the developing sleeve.

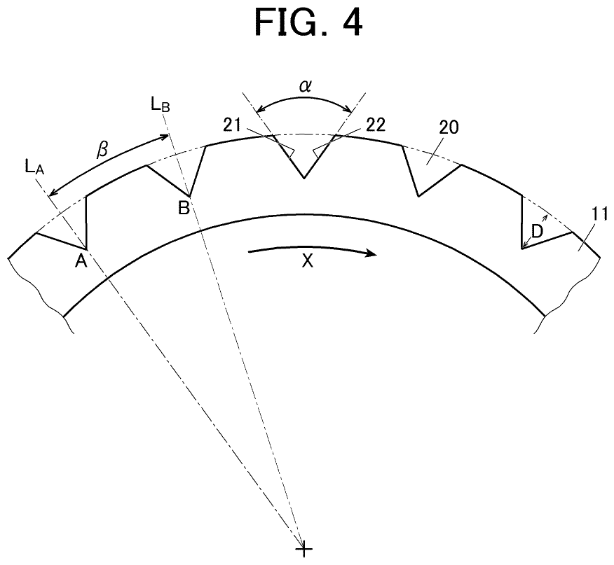

It is preferable that the surface of the developing sleeve according to the present invention has grooves from the viewpoint of improving the transportability of the developer. FIG. 4 is a partial enlarged view of a part of a cross section of a developing sleeve. The groove 20 is a V-shaped groove formed by an upstream wall surface 21 located on an upstream side and a downstream wall surface 22 located on a downstream side with respect to a rotation direction X of the developing sleeve 11. Note that the cross-sectional shape of the developing sleeve according to the present invention is not limited to a V-shaped groove shape like the groove 20 as illustrated in FIG. 4, and may be a flat bottom shape or an arc shape.

The developing sleeve 11 in which the grooves 20 are formed on the surface as described above is excellent in abrasion resistance and also excellent in transportability while carrying the developer on the surface. For example, by forming a plurality of grooves extending in the axial direction of the developing sleeve at predetermined intervals in the circumferential direction, the durability of the developing sleeve during long-term use is improved, and the developer transportability is improved.

The depth D of the grooves is preferably in a range of 40 to 120 m from the viewpoint of excellent transportability. The depth D of the groove can be calculated by photographing with a laser microscope (model: VKX-200) manufactured by Keyence Corporation.

The groove apex angle c is preferably 800 or more from the viewpoint of suppressing a decrease in the transportability due to clogging of the developer, and is preferably 120° or less from the viewpoint of improving the transportability of the developer.

The number of grooves in the circumferential direction of the developing sleeve is preferably in a range of 40 to 120.

The inter-groove angle β in FIG. 4 is 9° when the number of grooves is 40, and is 3° when the number of grooves is 120.

Note that the inter-groove angle β in FIG. 4 is an inter-groove angle formed by a straight line LA and a straight line LB. LA is a straight line drawn perpendicular to a specific vertex (vertex A) of the groove from a direction perpendicular to the surface of the developing sleeve. LB is a straight line drawn perpendicular to a vertex (vertex B) adjacent to the specific vertex A of the groove from the direction perpendicular to the surface of the developing sleeve. The inter-groove angle β is to be an angle smaller than 90°.

### 2. Image Forming Method

The image forming method according to the present invention is image forming using an electrostatic charge image developing toner and a developing sleeve that conveys the electrostatic charge image developing toner, wherein toner particles contained in the electrostatic charge image developing toner comprise an amorphous polyester that is a polycondensate of a polyvalent carboxylic acid and a polyhydric alcohol, the content percentage of a structural unit derived from a bisphenol A derivative in the amorphous polyester is 10 mol % or less based on the total structural units derived from the polyhydric alcohol, and the developing sleeve includes an aluminum alloy containing more than 0.6% by mass of silicon, and the image forming method can be suitably used in the image forming system of the present invention.

### 3. Electrophotographic Image Forming Apparatus

An electrophotographic image forming apparatus that can be used in the image forming system and the image forming method of the present invention includes, for example, a charging means, an exposure means, a developing means, and a transfer means.

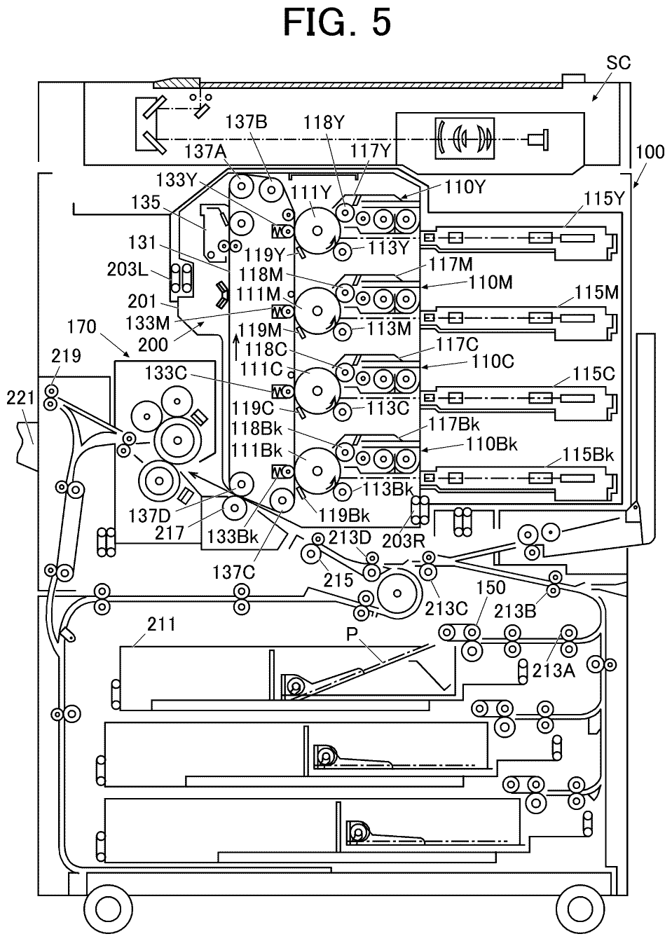

FIG. 5 is an explanatory cross-sectional view showing an example of the configuration of an electrophotographic image forming apparatus. An image forming apparatus 100 illustrated in FIG. 5 is called a tandem-type color image forming apparatus, and includes four image forming units 110Y, 110M, 110C, and 110Bk, a sheet feed conveyance means 150, and a fixing means 170.

At an upper part of the main body of the image forming apparatus 100, a document image reading device SC is arranged.

The image forming units 110Y, 110M, 110C, and 110Bk are arranged side by side in the vertical direction. The image forming units 110Y, 110M, 110C, and 110Bk include rotating drum-shaped photoreceptors 111Y, 111M, 111C, and 111Bk, charging units 113Y, 113M, 113C, ad 113Bk positioned sequentially along the rotation direction of the photoreceptors in the outer peripheral surface region thereof, exposure means 115Y, 115M, 115C, and 115Bk, developing means 117Y, 117M, 117C, and 117Bk, primary transfer rollers (primary transfer means) 133Y, 133M, 133C, and 133Bk, and cleaning means 119Y, 119M, 119C, and 119Bk.

Yellow (Y), magenta (M), cyan (C), and black (Bk) toner images are formed on the photoreceptors 111Y, 111M, 111C, and 111Bk, respectively.

Hereinafter, an example of the image forming unit 110Y will be described with reference to the drawings.

### <Charging Means>

The charging unit is a unit that uniformly charges the surface of the photoreceptor. The charging means includes a contact type such as a charging roller, a charging brush and a charging blade, and a non-contact type such as a corona charging device (corotron charging device, scorotron charging device and the like). Examples of the corona charger include a corotron charger, a scorotron charger, and the like. The charging means included in the image forming apparatus may be of a contact type or a non-contact type. The contact method is advantageous in that the amount of harmful ozone gas generated in the charging process is small. The non-contact method is not a proximity discharge compared with the contact method and has an advantage that filming is less likely to occur.

The charging means is preferably a proximity charging roller or a contact charging roller from the viewpoint that the amount of harmful ozone gas generated in the charging process is small and that it is advantageous for achieving higher image quality and downsizing of the apparatus.

The charging means 113Y illustrated in FIG. 5 is of a contact type. The charging means 113Y in this example is composed of a charging roller disposed in contact with the 111Y of the photoreceptor and a power source for applying a voltage to the charging roller.

### <Exposure Means>

The exposure means perform exposure on the photoreceptor to which the uniform potential is applied by the charging means based on the image signal and form an electrostatic latent image corresponding to an image. Examples of the exposure means include an exposure means including an LED in which light emitting elements are arranged in an array in the axial direction of the photoreceptor and an image forming element, and an exposure means of a laser optical system.

### <Developing Means>

The developing means (developing device) is a means for supplying a developer to the surface of the photoreceptor and developing the electrostatic latent image formed on the surface of the photoreceptor to form a toner image. Note that as the above-described developer, a developer containing the above-described toner and carrier is used.

The developing means may be provided with a lubricant supplying unit for supplying a lubricant to the developer, and the developer supplied by the developing means preferably contains a lubricant from the viewpoint of improving abrasion resistance. The lubricant is more preferably a metal soap from the viewpoint of improving abrasion resistance.

The developing means 117Y illustrated in FIG. 5 is, composed of a developing roller 118Y which has a built-in magnet and rotates while holding the developer, a photoreceptor 111Y, and a voltage application device (not illustrated) which applies DC and/or AC bias voltage between the photoreceptor 111Y and the developing roller 118Y.

As described above, the developing roller includes the developing sleeve, the flange, the shaft, and the magnet roller. The aluminum alloy of the developing roller has a silicon content of more than 0.6% by mass.

The developer is conveyed to the photoreceptor 118Y by the rotation of the developing roller 111Y. Next, the thin toner layer on the 118Y of the developing roller comes into contact with the 111Y of the photoreceptor and develops the electrostatic latent images on the 111Y of the photoreceptor.

The developing roller 118Y is connected to a voltage application device. By this voltage applying device, a DC and/or AC bias voltage (s) is/are applied to the developing roller 118Y. By controlling the voltage applied to the developing roller 118Y, the developing bias can be adjusted to a desired value.

Due to a potential difference (developing potential difference) between the potentials of the electrostatic latent images borne by the 118Y of the developing roller and the 111Y of the photoreceptor, an electric field is formed in a developing section where the 118Y of the developing roller and the 111Y of the photoreceptor face each other.

The toner in the developer conveyed to the developing section by the rotation of the developing roller 118Y moves by the action of the power received from the electric field, and is attracted to the electrostatic latent image on the photoreceptor 111Y.

When the electrostatic latent images carried on the photoreceptors 111Y are visualized, toner images corresponding to the shapes of the electrostatic latent images are formed on the surfaces of the photoreceptors 111Y.

### <Transfer Means>

The transfer means is a means for transferring the toner image on the photoreceptor to a transfer body such as an intermediate transfer body or a transfer material. When an intermediate transfer member is used, a primary transfer roller serves as a transfer unit. The “transfer means” in the present invention is means for transferring the “toner image on the photoreceptor”, and therefore, the secondary transfer roller used in the transfer from the intermediate transfer member to the transfer material is not included in the “transfer means”.

The primary transfer roller 133Y shown in FIG. 5 transfers the toner image formed on the photoreceptor 111Y to an intermediate transfer body 131 in the form of an endless belt. The primary transfer roller 133Y is disposed in contact with the intermediate transfer body 131.

In the image forming apparatus 100 illustrated in FIG. 5, the toner images formed on the photoreceptors 111Y, 111M, 111C, and 111Bk are transferred to the intermediate transfer body 131 by primary transfer rollers (primary transfer units) 133Y, 133M, 133C, and 133Bk. Then, an intermediate transfer method is adopted in which each toner image transferred onto the intermediate transfer body 131 is transferred onto a transfer material P by a secondary transfer roller (secondary transfer means) 217. The transfer unit is not limited to an intermediate transfer method, and a direct transfer method in which the toner image formed on the photoreceptor is directly transferred to the transfer material P by the transfer unit may be adopted.

By the above-described means of the present invention, an image forming system and an image forming method can be provided in which image failure such as black spots and fogging is suppressed and which are excellent in low-temperature fixing ability and heat resistance. The expression mechanism or action mechanism of the effect of the present invention is not clear, but it is presumed as follows.

An image forming system of the present invention includes: an electrostatic charge image developing toner including toner particles containing an amorphous polyester in which a content percentage of a structural unit derived from a bisphenol A derivative is 10 mol % or less with respect to all structural units derived from a polyhydric alcohol; and a developing sleeve including an aluminum alloy containing more than 0.6% by mass of silicon.

As described above, the bisphenol A derivative has a structure containing many aromatic rings in the molecule, and therefore has a feature that the molecule is very rigid and hardly moves. In the present invention, when the content percentage of the structural unit derived from the bisphenol A derivative in the amorphous polyester is 10 mol % or less with respect to the total structural units derived from the polyhydric alcohol, the movement of charges in the molecule is facilitated, and the rise of the charge amount is accelerated.

However, when the content percentage of the structural unit derived from a bisphenol A derivative is 10 mol % or less as described above, the glass transition temperature (Tg) of the toner decreases, and thus the amount of heat generated on the developing sleeve increases during image formation, which causes the toner to aggregate and image failure such as black spots occurs.

Here, the developing sleeve used in the image forming system of the present invention contains an aluminum alloy containing more than 0.6% by mass of silicon and has a high surface resistance value. Therefore, heat generation during image formation is suppressed.

In the image forming system of the present invention, the content percentage of the structural unit derived from a bisphenol A derivative is set within the above-described range at the time of image formation, and then the above-described developing sleeve is used in combination. Thus, it is presumed that while adverse effects caused when the amount of the bisphenol A derivative used is reduced are suppressed, heat generation on the developing sleeve is suppressed without becoming excessive, and image failure such as black spots can be suppressed.

### EXAMPLES

Hereinafter, the present invention will be specifically described with reference to Examples, but the present invention is not limited thereto. In Examples, “part(s)” or “%” means “part(s) by mass” or “% by mass” unless otherwise specified.

### A. Production of Developing Sleeve 1

### (A. 1) Production of a Hollow Cylindrical Tube of an Aluminum Alloy

The hollow cylindrical tube was prepared using, as the aluminum alloy containing silicon (Si), an aluminum alloy in which the content of silicon (Si) was set to 0.7% by mass with respect to the total mass of the aluminum alloy.

### (A. 2) Formation of Grooves

The surface shape of the V-shaped grooves was formed on the hollow cylindrical tube at equal intervals in the circumferential direction, and the outer peripheral surface of the cylinder was subjected to a sandblast treatment by spraying glass beads with a blast gun, whereby a developing sleeve 1 was produced. As for the V-shaped grooves, for example, as shown in FIG. 4, the depth D of the groove was 75±25 μm, the V-shaped groove apex angle α was 100°, the number of grooves in the circumferential direction of the developing sleeve was 40, and the inter-groove angle β was 9°. Note that the developing sleeve 1 was made to have an outer diameter of 16 mm and thickness of 1 mm. Note that the processing conditions of the sandblasting treatment are as follows.

### <Processing Conditions>

Type of glass beads: FGB #80 (manufactured by Fuji Manufacturing Co., Ltd.)
Feed rate of glass beads: 200 g/min
Ejection distance from blast gun to cylinder: 100 mm
Movement speed of blast gun: 5.0 cm/sec
Compressed air pressure: 0.23 MPa
Rotation speed of cylinder: 545 rpm

In addition, the surface of the developing sleeve 1 was photographed with a laser microscope (model: VKX 200) manufactured by Keyence Corporation, and the depth D of the groove in the circumferential direction of the support was measured. Specifically, a total of 12 points of 3 points in the axial direction and 4 points in the circumferential direction of the support were photographed at a magnification of 500. The captured image was binarized using image analysis software, and the depths D of all the linear grooves in the image were calculated. When the range of the depth D of 90% or more of the entire linear grooves was calculated from the calculated depths of the linear grooves, the range was 100 μm.

### B. Production of Developing Sleeves 2 to 7

### (B. 1) Preparation of Aluminum Alloy and Production of Hollow Cylindrical Tube

As the aluminum alloy containing silicon (Si), the one described in Table I was used to form the hollow cylindrical tube. Note that the developing sleeve 7 contained 0.7% by mass of lithium (Li).

### (B. 2) Formation of Grooves

Grooves were formed at equal intervals in a circumferential direction in the hollow cylindrical tube, to form a surface shape of V-shaped grooves. As the V-shaped grooves, for example, as illustrated in FIG. 4, grooves similar to those of the developing sleeve 1 were formed with a groove depth D of 75±25 μm, the V-shaped groove apex angle α was 100°, the number of grooves in the circumferential direction of the developing sleeve was 40, and the inter-groove angle β was 9°.

All of the developing sleeves 2 to 19 were made of outer diameter 16 mm and had 1 mm thicknesses.

TABLE I

Al ALLOY

| | |
|---|---|
| Si | Li |

| | |
|---|---|
| DEVELOPING | CONTENT |
| SLEEVE No. | [% BY MASS] |

| | | |
|---|---|---|
| 1 | 0.7 | 0.0 |
| 2 | 1.0 | 0.0 |
| 3 | 1.4 | 0.0 |
| 4 | 5.0 | 0.0 |
| 5 | 0.0 | 0.0 |
| 6 | 0.0 | 0.7 |

In the above table, “Al” represents aluminum, “Si” represents silicon, and “Li” represents lithium.

### C. Preparation of Amorphous Polyester Particle Dispersion Liquid

### (C.1) Amorphous Polyester Particle Dispersion Liquid (AP1)

### (C.1.1) Synthesis of Amorphous Polyester

The following monomers of the amorphous polyester were placed in a four-necked flask equipped with a nitrogen inlet tube, a dewatering tube, a stirrer, and a thermocouple, and were heated to 170° C. to be dissolved.

### <Polyhydric Alcohol>

| | |
|---|---|
| ethylene glycol | 50 parts by mole |
| neopentyl glycol | 50 parts by mole |

### <Polyvalent Carboxylic Acid>

| | |
|---|---|
| terephthalic acid | 55 parts by mole |
| fumaric acid | 5 parts by mole |
| dodecenyl succinic acid | 40 parts by mole |

Under stirring, the mixed liquid in the dropping funnel was added dropwise to the four-necked flask over 90 minutes, and after aging for 60 minutes, the unreacted monomer was removed under reduced pressure (8 kPa). Thereafter, Ti (OBu) 4 was added in an amount of 0.003% by weight with relation to the total amount of the polyvalent carboxylic acid components, and the mixture was heated to 235° C. and allowed to react under ordinary pressure (101. 3 kPa) for 5 hours. The mixture was further reacted under reduced pressure (8 kPa) for 1 hour. Next, the mixture was cooled to 200° C., allowed to react under reduced pressure (20 kPa), and the followed by desolvation to synthesize amorphous polyester [a1].

### (C. 1.2) Preparation of Amorphous Polyester Particle Dispersion

108 parts by weight of the synthesized amorphous polyester [a1] was put in 64 parts by weight of methylethyl ketone and stirred at 70° C. for 30 minutes to be dissolved. Next, an aqueous solution prepared by dissolving sodium polyoxyethylene lauryl ether sulfate in 26 parts by mass of ion-exchanged water so as to have a concentration of 1% by mass was added to the solution.

Subsequently, 3.4 parts by weight of a 25% by weight aqueous sodium hydroxide solution were added. This solution was placed in a reaction vessel with a stirrer, and 270 parts by mass of ion-exchanged water warmed to 70° C. was added dropwise thereto over 70 minutes with stirring.

The liquid in the container became cloudy during the dropwise addition, and a uniformly emulsified state was obtained after the dropwise addition of the entire amount. The particle diameter of oil droplets in the emulsion was measured with a laser diffraction particle size distribution analyzer “LA-750” manufactured by HORIBA, Ltd, and as a result, the volume mean particle diameter was 90 nm.

Next, while the emulsion was maintained at 70° C., methyl ethyl ketone was removed by distillation by stirring the emulsion for 1 hour under reduced pressure at 15 kPa (150 mbar) using a diaphragm pump “V-700” manufactured by Buchi Labortechnik GmbH, thereby preparing an amorphous polyester particle dispersion liquid (AP1) in which fine particles of the amorphous polyester [a1] were dispersed.

The solid content of the obtained amorphous polyester particle dispersion liquid (AP1) was 24%. As a result of measurement with a particle size distribution analyzer, the volume-mean particle diameter of the fine particles of the amorphous polyester [a1] in the amorphous polyester particle dispersion liquid (AP1) was 94 nm.

### (C. 2) Amorphous Polyester Particle Dispersion Liquids (AP2) to (AP7)

The amorphous polyesters [a2] to [a7] were synthesized in the same manner as the amorphous polyester [a1] in the synthesis of the amorphous polyester except that the monomers in the amounts listed in Table II were added as the polyhydric alcohol component. Furthermore, at that time, as the polyvalent carboxylic acid, a monomer similar to that of the amorphous polyester [a1] was added in a similar amount. Amorphous polyester particle dispersion liquids (AP2) to (AP7) were prepared in the same manner as the amorphous polyester particle dispersion liquid (AP1) except the above.

TABLE II

| AMORPHOUS | | CONTENT PERCENTAGE WITH RESPECT TO ALL STRUCTURAL | | | | | | |
|---|---|---|---|---|---|---|---|---|
| POLYESTER | | UNITS DERIVED FROM POLYHYDRIC ALCOHOL [mol %] | | | | | | |
| DISPERSION | | BPA DERIVATIVE | | | ALIPHATIC ALCOHOL | | | |
| LIQUID | RESIN | BPA-EO | BPA-PO | TOTAL | EG | NPG | PG | Pen-DO |
| (AP1) | [a1] | 0.00 | 0.00 | 0 | 50 | 50 | — | — |
| (AP2) | [a2] | 1.00 | 5.00 | 6 | 47 | 47 | — | — |
| (AP3) | [a3] | 1.67 | 8.35 | 10 | 45 | 45 | — | — |
| (AP4) | [a4] | 0.00 | 0.00 | 0 | 50 | — | 50 | — |
| (AP5) | [a5] | 0.00 | 0.00 | 0 | 50 | — | — | 50 |
| (AP6) | [a6] | 8.35 | 41.75 | 50 | 25 | 25 | — | — |
| (AP7) | [a7] | 16.70 | 83.50 | 100 | — | — | — | — |

In the table, “BPA-EO” represents bisphenol A ethylene oxide adduct, “BPA-PO” represents bisphenol A propylene oxide adduct, “EG” represents ethylene glycol, “NPG” represents neopentyl glycol, “PG” represents propane glycol, “Pen-DO” represents 1,5 pentanediol.

### D. Preparation of Crystalline Polyester Particle Dispersion Liquid

### (D. 1) Crystalline Polyester Particle Dispersion Liquid (CP1)

### (D. 1.1) Synthesis of Crystalline Polyester

The following raw material monomers for a polycondensation resin (crystalline polyester) unit were placed in a four-necked flask equipped with a nitrogen introduction tube, a dehydration tube, a stirrer, and a thermocouple, and were heated to 170° C. to be dissolved. Hereinafter, the “crystalline polyester” is also referred to as “CPEs”.

| | |
|---|---|
| sebacic acid (polyvalent carboxylic acid) | 60 parts by mole |
| 1,6-hexanediol (polyhydric alcohol) | 40 parts by mole |

Next, the monomer was placed in a reaction vessel equipped with a stirrer, a thermometer, a cooling tube, and a nitrogen gas introduction tube, and the inside of the reaction vessel was replaced with dry nitrogen gas. To the obtained mixture, Ti (OBu) 4 was added in an amount of 0.003% by weight with relation to the total amount of the polyvalent carboxylic acid components, and the mixture was heated to 235° C. and allowed to react under ordinary pressure (101. 3 kPa) for 5 hours. The mixture was further reacted under reduced pressure (8 kPa) for 1 hour. Next, the obtained reactant was cooled to 200° C. and then allowed to react under reduced pressure (20 kPa) for 1 hour to synthesize crystalline polyester [c1].

### (D. 1.2) Preparation of Crystalline Polyester Particle Dispersion Liquid

174 parts by weight of the synthesized crystalline polyester [c1] was put in 102 parts by weight of methylethyl ketone, and stirred at 75° C. for 30 minutes to be dissolved. Next, an aqueous solution prepared by dissolving sodium polyoxyethylene lauryl ether sulfate in 26 parts by mass of ion-exchanged water so as to have a concentration of 1% by mass was added to the solution.

Subsequently, 4.6 parts by weight of a 25% by weight aqueous sodium hydroxide solution were added. This solution was placed in a reaction vessel with a stirrer, and while stirring, 375 parts by mass of water warmed to 70° C. was added dropwise over 70 minutes and mixed. The liquid in the container became cloudy during the dropwise addition, and a uniformly emulsified state was obtained after the dropwise addition of the entire amount.

Next, while the emulsion was kept at 70° C., methyl ethyl ketone was removed by distillation by stirring the emulsion for 1 hour under reduced pressure with a 15 kPa (150 mbar) using a diaphragm pump “V-700” manufactured by Buchi Labortechnik GmbH, and then the emulsion was cooled at a cooling rate of 6° C./min to prepare the crystalline polyester particle dispersion liquid [CP1] in which fine particles of the crystalline polyester (c1) were dispersed.

The solid content of the obtained crystalline polyester particle dispersion (CP1) was 25%. As a result of measurement with the particle size distribution analyzer, the volume mean particle diameter of the crystalline resin fine particles in the crystalline resin fine particle dispersion liquid was 202 nm.

### (D. 2) Crystalline Polyester Particle Dispersion Liquids (CP2) to (CP4)

In the synthesis of the crystalline polyester, the same procedure as for the crystalline polyester [c1] was performed except that in the synthesis of the crystalline polyesters [c2] to [c4], monomers in the amounts described in Table III were added as the polyvalent carboxylic acid and the polyhydric alcohol components. Crystalline polyester particle dispersion liquids (CP2) to (CP4) were prepared in the same manner as the crystalline polyester particle dispersion liquid (CP1) except the above.

TABLE III

| CRYSTALLINE | | POLYVALENT CARBOXYLIC ACID COMPONENT | | | POLYHYDRIC ALCOHOL COMPONENT | | |
|---|---|---|---|---|---|---|---|
| POLYESTER | | | | ADDED AMOUNT | | | ADDED AMOUNT |
| DISPERSION | | | CARBON | [PARTS BY | | CARBON | [PARTS BY |
| LIQUID | RESIN | NAME | ATOMS | MOLE] | NAME | ATOMS | MOLE] |
| (CP1) | c1 | SEBACIC ACID | 10 | 60 | 1,6- | 6 | 40 |
| | | | | | HEXANEDIOL | | |
| (CP2) | c2 | SUCCINIC ACID | 4 | 60 | 1,4- | 4 | 40 |
| | | | | | BUTANEDIOL | | |
| (CP3) | c3 | DODECANEDIOIC | 12 | 60 | 1,6- | 6 | 40 |
| | | ACID | | | HEXANEDIOL | | |
| (CP4) | c4 | DODECANEDIOIC | 12 | 60 | 1, 9- | 9 | 40 |
| | | ACID | | | NONANEDIOL | | |

### E. Preparation of Coloring Agent Particle Dispersion Liquid

(Dispersion Liquid of Coloring Agent particle (P1))

While a solution obtained by adding 226 parts by mass of sodium dodecyl sulfate to 1600 parts by mass of ion-exchanged water was being stirred, 420 parts by mass of copper phthalocyanine (C. I. Pigment Blue 15:3) was gradually added thereto.

The resultant was subjected to dispersion treatment using a stirring apparatus, CLEARMIX (manufactured by M Technique Co., Ltd) (“CLEARMIX” is a registered trademark of the company) to prepare a coloring agent particle dispersion liquid (P1). The volume-based median diameter of the coloring agent particles in the dispersion was 110 nm.

### F. Preparation of Release Agent Particle Dispersion Liquid

### (F.1) Release Agent Particle Dispersion Liquid (W1)

The following components were heated to 110° C. and dispersed using an “ULTRATURRAX T50” homogenizer manufactured by Ika-Werke GmbH & Co. KG, followed by dispersion processing using a Manton-Gaulin high-pressure homogenizer manufactured by Gaulin, to prepare a release agent dispersion liquid (W1) in which a release agent having a mean particle diameter of 0.21 μm was dispersed. The release agent dispersion liquid (W1) had a release agent concentration of 26% by mass.

### <Components>

| | | |
|---|---|---|
| release agent “HNP-9” (manufactured by Nippon | 50 | parts by mass |
| Seiro Co., Ltd) | | |
| anionic surfactant “NEOGEN RK” (DKS Co., | 5 | parts by mass |
| Ltd)) | | |
| ion -exchanged water | 200 | parts by mass |

The volume mean particle diameter of the fine particles in the dispersion liquid of release agent particles (W1) was measured using Microtrac UPA-150 (manufactured by Nikkiso Co., Ltd.) and found to be 215 nm.

### (F.2) Release Agent Particle Dispersion Liquids (W2) to (W6)

Release agent particles dispersion liquids (W2) to (W6) are prepared in the same manner as the release agent particle dispersion liquid (W1), except that 50 parts by weight of the release agent listed in Table IV is added instead of the release agent “HNP-9” (manufactured by Nippon Seiro Co., Ltd.).

TABLE IV

| RELEASE | | | ADDED |
|---|---|---|---|
| AGENT | | | AMOUNT |
| DISPER- | | MELTING | [PARTS |
| SION | | POINT | BY |
| LIQUID | NAME | [° C.] | MASS] |
| (W1) | HNP-9 | 75.0 | 50 |
| | (MANUFACTURED BY | | |
| | NIPPON SEIRO CO., | | |
| | LTD) | | |
| (W2) | STEARYL STEARATE | 67.3 | 50 |
| (W3) | C80 (MANUFACTURED | 84.4 | 50 |
| | BY SASOL LTD) | | |
| (W4) | FNP0090 (MANUFACTURED | 90.5 | 50 |
| | BY NIPPON SEIRO CO., | | |
| | LTD) | | |
| (W5) | NCM9395(MANUFACTURED | 91.7 | 50 |
| | BY SASOL LTD) | | |
| (W6) | WEP-3(NOF CORPORATION) | 72.0 | 50 |

### G. Preparation of Toner Particles

### (G.1) Toner Particles [1]

The materials listed below were placed in a round stainless steel flask, the pH level was adjusted to 3.5 by the addition of 0.1 N nitrate, and an aqueous solution of poly (aluminum chloride) (PAC) prepared by dissolving 2.0 parts of PAC, which is a 30% powder product manufactured by Oji Paper Co., Ltd., in 30 parts of ion-exchanged distilled water was added.

### <Materials>

| | | |
|---|---|---|
| ion -exchanged water | 200 | parts by mass |
| amorphous polyester particle dispersion liquid | 150 | parts by weight |
| (AP1) | | |
| crystalline polyester particle dispersion liquid | 40 | parts by weight |
| (CP1) | | |
| coloring agent particle dispersion liquid (P1) | 15 | parts by weight |
| release agent particle dispersion liquid (W1) | 10 | parts by weight |
| anionic surfactant (TaycaPower) | 2.8 | parts by mass |

The materials were dispersed at 30° C. using a homogenizer “ULTRA-TURRAX T50” manufactured by Ika-Werke GmbH & Co. KG, then heated to 45° C. in a heating oil bath, and held until the volume mean particle diameter of the toner particles prepared with the materials described above became 4.1 μm.

Thereafter, 60 parts by weight of the amorphous polyester particle dispersion liquid (AP1) is added and the mixture is held for 30 minutes. Thereafter, when the volume mean particle diameter of the toner particles reaches 4.5 μm, 60 parts by weight of the amorphous polyester particle dispersion liquid (A1) is further added, and the mixture is held for 30 minutes.

Subsequently, 20 parts by weight of a 10% NTA metallic salt solution “CHELEST 70” manufactured by Chelest Corporation was added thereto, and then the pH level was adjusted to 9.0 with a 1 N sodium hydroxide aqueous solution. Note that “NTA” is an abbreviation for nitrilotriacetic acid. Thereafter, 1.0 parts by weight of an anionic active agent “TaycaPower” is added thereto, and the mixture is heated to 85° C. while being continuously stirred and is held for 5 hours.

Thereafter, the mixture was cooled to 20° C. at a rate of 20° C./min, filtered, and then sufficiently washed with ion exchanged water. The resultant hydrous toner was dried with a 2-inch continuous instantaneous airflow dryer “Flash Jet Dryer” produced by Seishin Enterprise Co., Ltd., to prepare toner particles [1] having a volume mean particle diameter of 5.0 μm.

### (G.2) Toner Particles [2] to [22]

Except that the amorphous polyester particle dispersion liquid, the crystalline polyester particle dispersion liquid, and the release agent particle dispersion liquid in the production of the toner particles [1] were each changed to those described in Table V, the toner particles [2] to [22] were prepared in the same manner as in the preparation of the toner particle [1].

### H. Preparation of External Additive

### (H. 1) External Additive [1]

In a 3-liter reaction vessel equipped with a stirrer, a dropping funnel, and a thermometer, 945 parts by mass of methanol, 45 parts by mass of 28% aqueous ammonia, and 135 parts by mass of water were added and mixed. The temperature of the solution was adjusted to 35° C., 405 parts by mass of tetramethoxysilane was added dropwise thereto over 6 hours with stirring, and after the dropwise addition, stirring was further continued for 1 hour to perform hydrolysis, thereby obtaining a suspension of silica particles. The dispersion liquid was distilled under reduced pressure and dried, and then the fine particles were cracked to prepare an external additive [1] (silica particle [S1]) having a particle diameter of 110 nm. External additive [1] is silica particle [S1].

### (H.2) External Additives [2] to [4]

Silica particles [S2] to [S4] having number mean particle diameters shown in Table V were produced by controlling the weight ratio of methanol to aqueous ammonia and water and the temperature of the solutions in the production of the external additive [1], that is, silica particle [S1]. The silica particles [S2] to [S4] are referred to as an external additive [2] to an external additive [4].

### I. Preparation of Developer

### (1.1) Developer 1

### (Preparation of Toner 1)

To 100 parts by weight of the toner particle [1], 1.5 parts by weight of the external additive [1] having a particle diameter of 110 nm, that is, the silica particles [1] were added, and the resulting mixture was mixed with a Henschel mixer (manufactured by Nippon Coke & Engineering Co., Ltd.) at a rotor peripheral speed of 35 mm/sec and 32° C. for 20 minutes, to prepare toner 1.

### (Mixture of Carriers)

Thereafter, the toner 1 from which coarse particles have been removed with a sieve having an opening of 45 μm and a ferrite carrier coated with an acrylic resin and having a volume mean particle diameter of 32 μm are added and mixed so that the toner particle concentration is 6% by mass, to produce a developer 1.

### (1.2) Developers 2 to 22

### (Production of Toners 2 to 22)

Toners 2 to 22 were produced in the same manner as in the production of the toner 1 except that the external additive [1], that is, the silica particle [1] was changed to the respective external additive described in Table V.

### (Mixture of Carriers)

Thereafter, the toners 2 to 22 from which coarse particles have been removed with a sieve having an opening of 45 μm and a ferrite carrier coated with an acrylic resin and having a volume mean particle diameter of 32 μm are added and mixed so that the toner particle concentration is 6% by mass, to produce the developers 2 to 22.

TABLE V

| | TONER | | | | | | | |
|---|---|---|---|---|---|---|---|---|
| | | AMORPHOUS | CRYSTALLINE | RELEASE | | EXTERNAL ADDITIVE | | |
| | | POLYESTER | POLYESTER | AGENT | BPA CONTENT | | PARTICLE | |
| DEVELOPER | | DISPERSION | DISPERSION | DISPERSION | PERCENTAGE | | DIAMETER | |
| No. | No. | LIQUID | LIQUID | LIQUID | [moL %] | No. | [nm] | CARRIER |
| 1 | 1 | (AP1) | (CP1) | (W1) | 0 | [1] | 110 | PRESENT |
| 2 | 2 | (AP2) | (CP1) | (W1) | 6 | [1] | 110 | PRESENT |
| 3 | 3 | (AP3) | (CP1) | (W1) | 10 | [1] | 110 | PRESENT |
| 4 | 4 | (AP1) | (CP2) | (W1) | 0 | [1] | 110 | PRESENT |
| 5 | 5 | (AP4) | (CP1) | (W1) | 0 | [1] | 110 | PRESENT |
| 6 | 6 | (AP1) | (CP1) | (W1) | 0 | [1] | 110 | PRESENT |
| 7 | 7 | (AP1) | (CP1) | (W1) | 0 | [1] | 110 | PRESENT |
| 8 | 8 | (AP1) | (CP1) | (W1) | 0 | [1] | 110 | PRESENT |
| 9 | 9 | (AP1) | (CP1) | (W2) | 0 | [1] | 110 | PRESENT |
| 10 | 10 | (AP1) | (CP1) | (W1) | 0 | [2] | 80 | PRESENT |
| 11 | 11 | (AP1) | (CP1) | (W1) | 0 | [3] | 135 | PRESENT |
| 12 | 12 | (AP5) | (CP1) | (W1) | 0 | [1] | 110 | PRESENT |
| 13 | 13 | (AP1) | (CP3) | (W1) | 0 | [1] | 110 | PRESENT |
| 14 | 14 | (AP1) | (CP4) | (W1) | 0 | [1] | 110 | PRESENT |
| 15 | 15 | (AP1) | (CP1) | (W3) | 0 | [1] | 110 | PRESENT |
| 16 | 16 | (AP1) | (CP1) | (W4) | 0 | [1] | 110 | PRESENT |
| 17 | 17 | (AP1) | (CP1) | (W5) | 0 | [1] | 110 | PRESENT |
| 18 | 18 | (AP1) | (CP3) | (W6) | 0 | [4] | 7 | PRESENT |
| 19 | 19 | (AP1) | (CP1) | (W1) | 0 | [1] | 110 | PRESENT |
| 20 | 20 | (AP1) | (CP1) | (W1) | 0 | [1] | 110 | PRESENT |
| 21 | 21 | (AP6) | (CP1) | (W1) | 50 | [1] | 110 | PRESENT |
| 22 | 22 | (AP7) | (CP1) | (W1) | 100 | [1] | 110 | PRESENT |

In the above table, “BPA content” represents the content percentage of structural units derived from bisphenol A derivatives in amorphous polyesters.

### J. Evaluation

### (Preparation)

A magnet roller, a shaft, and a flange were attached to each of the produced developing sleeves 1 to 6. Developing rollers 1 to 6 were prepared and mounted as developing rollers used in developing means in “bizhub C658” manufactured by Konica Minolta, Inc. in each of examples and comparative examples in a normal-temperature and normal-humidity environment (NN environment; temperature of 23° C. and relative humidity of 50%). Furthermore, developers 1 to 22 were loaded for each of the examples and the comparative examples.

### (J.1) Black Spot

### (Evaluation Method)

A character chart having a mean printing rate of 5% was continuously printed on 400000 sheets in the NN environment. Thereafter, 100 sheets of each color (Y, M, C, and Bk) were output on POD gloss coat (A3 size, 100 g/m 2, manufactured by Oji Paper Co., Ltd) in a high-temperature and high-humidity environment (HH environment; temperature of 30° C. and relative humidity of 85%).

A total of eight sheets of each of Y, M, C, and Bk, i.e., the first sheet and the 100th sheet of each color, were visually observed, and image evaluation was performed according to the following evaluation criteria. As evaluation criteria, “A”, “B”, and “D” were used. “A” and “B” were determined to be levels having no problem in practical use, and were regarded as passing. Furthermore, “D” was determined to be a level at which there was a problem in practical use, and was evaluated as failure. The evaluation results are shown in Table VI.

### (Evaluation Criteria)

A: No image defect of black spots was observed in any of the eight sheets, and there was no problem in practical use.
B: Although a black spot can be confirmed in at least one of the eight sheets, there is no practical problem.
D: In at least any one of the eight sheets, black spots are conspicuously and obviously generated, the quality is unacceptable, and image failure at a level problematic in practical use is observed.

### (J.2) Fogging

### (Evaluation Method)

The fogging on the image was evaluated according to the following evaluation criteria by printing an image having a pixel ratio of 45% on 5000 sheets of A4 size high-quality paper (64 g/m 2/) under a low-temperature and low-humidity environment (temperature of 10° C. and relative humidity of 15%), then printing a blank sheet, and measuring the density of the blank sheet of the transfer material with a reflection densitometer “RD-918” manufactured by Macbeth. Note that the white paper density of the transfer material was measured at 20 places in the A4 size, and the mean value was defined as the white paper density. As evaluation criteria, “A”, “B”, “C”, and “D” were used. “A”, “B”, and “C” were determined to be a level with no practical problem and were considered to be acceptable. Furthermore, “D” was determined to be a level at which there was a problem in practical use, and was evaluated as failure. The evaluation results are shown in Table VI.

### (Evaluation Criteria)

A: The fogging density is less than 0.005, which is a good level.
B: The fogging density is 0.005 or more and less than 0.008, which is a level causing no practical problem.
C: The fogging density is 0.008 or more and less than 0.012, which is a level causing no practical problem.
D: When the fogging density is 0.012 or more, it is a level which causes a practical problem.

### (J.3) Low-Temperature Fixability

### (Evaluation Method)

The fixing device of a multifunction peripheral “bizhub PRESS (Registered Trademark) C1070” manufactured by Konica Minolta, Inc. was modified so that the temperatures of the surfaces of the fixing upper belt and the fixing lower roller could be changed, and the two-component developers were sequentially loaded. The above-described apparatus was modified so that the fixing temperature, the toner adhesion amount, and the system speed could be freely set.

Under a normal-temperature and normal-humidity (temperature: 20° C., relative humidity: 50%) environment, the toner adhesion amount was set to be 11.3 g/m 2 on 127.9 g/m 2 high-quality paper “NPI high-quality” with a A4 size manufactured by Nippon Paper Industries Co., Ltd.

Thereafter, a fixing experiment for fixing an image having a 100 mm×100 mm size was repeatedly performed up to 180° C. while changing the set fixing temperature from 110° C. so as to increase in increments of 2° C. The lowest fixing temperature at which image contamination due to fixing offset was not visually observed was defined as the lowest fixing temperature (U. O. avoidance temperature). The measured value of the lowest fixing temperature was used for evaluation according to the following evaluation criteria.

As evaluation criteria, “A”, “B”, “C”, and “D” were used. “A”, “B”, and “C” were determined to be a level with no practical problem and were considered to be acceptable. Furthermore, “D” was determined to be a level at which there was a problem in practical use, and was evaluated as failure. The evaluation results are shown in Table VI.

### (Evaluation Criteria)

A: The minimum fixing temperature is lower than 130° C.
B: The lowest fixing temperature is 130° C. or more and less than 135° C.
C: The minimum fixing temperature is 135° C. or more and less than 140° C.
D: The lowest fixing temperature is 140° C. or more.

### (J.4) Heat Resistance of Toner

### (Evaluation Method)

The toner 0.5 g portion of each of the produced toners was placed in a 10 mL glass bottle with a 21 mm inside diameter, the lid was closed, and the bottle was shaken 600 times at room temperature using a shaker “Tap Denser KYT-2000” produced by Seishin Enterprise Co., Ltd. Thereafter, the container was allowed to stand for 2 hours in an environment at a temperature of 55° C. and a humidity of 35% RH with the lid opened.

Next, the toner was placed on a 48-mesh sieve having an opening of 350 μm while taking care not to crush aggregates of the toner, and the sieve was set in “Powder Tester” manufactured by Hosokawa Micron Corporation, and fixed with a pressing bar and a knob nut. After the vibration intensity was adjusted to a vibration intensity providing a 1 mm in the feed rate and vibration was applied for 10 seconds, the ratio (% by weight) of the amount of the toner remaining on the sieve was measured and the toner aggregation rate was calculated by the following formula (A).

toner aggregation rate[%]=(weight of remaining toner on sieve[g])/0.5 [g]×100) Formula (A)

The same measurement is performed at temperatures of 57.5° C. and 60° C., and the results are plotted with the X axis representing temperature and the Y axis representing toner aggregation rate. Temperature 55° C., 57.5° C. Within 60° C., an approximate straight line is drawn between two temperatures sandwiching the region where the toner aggregation rate is 50%, and the temperature where the toner aggregation rate is 50% is calculated from interpolation. The temperature at that time was measured and regarded as the temperature of heat resistance, which was evaluated according to the following evaluation criteria.

As evaluation criteria, “A”, “B”, “C”, and “D” were used. “A”, “B”, and “C” were determined to be a level with no practical problem and were considered to be acceptable. Furthermore, “D” was determined to be a level at which there was a problem in practical use, and was evaluated as failure. The evaluation results are shown in Table VI.

### (Evaluation Criteria)

A: 59° C. or higher.
B: 58° C. or more and less than 59° C.
C: 57° C. or more and less than 58° C.
D: less than 57° C.

TABLE VI

| | DEVELOPING | | | | | | | | | | | | |
|---|---|---|---|---|---|---|---|---|---|---|---|---|---|
| | SLEEVE | | | TONER | | | | | | | | | |
| | | Al ALLOY | | | | | | | EXTERNAL | | | | |
| | | Si | Li | | | | | | ADDITIVE | | | | |
| EXAMPLE OR | | CONTENT | | | POLYESTER | | | BPA CONTENT | PARTICLE | EVALUATION | | | |
| COMPARATIVE | | [% BY | | | DISPERSION | | | PERCENTAGE | DIAMETER | BLACK | | | HEAT |
| EXAMPLE | No. | MASS] | | No. | LIQUID | | *1 | [moL %] | [nm] | SPOT | FOGGING | *2 | RESISTANCE |
| EXAMPLE 1 | 1 | 0.7 | — | 1 | AP1 | CP1 | W1 | 0 | 110 | B | A | A | A |
| EXAMPLE 2 | 1 | 0.7 | — | 2 | AP2 | CP1 | W1 | 6 | 110 | B | A | A | A |
| EXAMPLE 3 | 1 | 0.7 | — | 3 | AP3 | CP1 | W1 | 10 | 110 | B | A | A | A |
| EXAMPLE 4 | 1 | 0.7 | — | 4 | AP1 | CP2 | W1 | 0 | 110 | B | A | B | A |
| EXAMPLE 5 | 1 | 0.7 | — | 5 | AP4 | CP1 | W1 | 0 | 110 | B | A | B | A |
| EXAMPLE 6 | 2 | 1.0 | — | 6 | AP1 | CP1 | W1 | 0 | 110 | A | A | A | A |
| EXAMPLE 7 | 3 | 1.4 | — | 7 | AP1 | CP1 | W1 | 0 | 110 | A | A | A | A |
| EXAMPLE 8 | 4 | 5.0 | — | 8 | AP1 | CP1 | W1 | 0 | 110 | B | A | A | A |
| EXAMPLE 9 | 3 | 1.4 | — | 9 | AP1 | CP1 | W2 | 0 | 110 | B | A | A | B |
| EXAMPLE 10 | 3 | 1.4 | — | 10 | AP1 | CP1 | W1 | 0 | 80 | B | A | A | B |
| EXAMPLE 11 | 3 | 1.4 | — | 11 | AP1 | CP1 | W1 | 0 | 135 | B | A | A | B |
| EXAMPLE 12 | 3 | 1.4 | — | 12 | AP5 | CP1 | W1 | 0 | 110 | A | A | A | A |
| EXAMPLE 13 | 3 | 1.4 | — | 13 | AP1 | CP3 | W1 | 0 | 110 | A | A | A | A |
| EXAMPLE 14 | 3 | 1.4 | — | 14 | AP1 | CP4 | W1 | 0 | 110 | A | A | A | A |
| EXAMPLE 15 | 3 | 1.4 | — | 15 | AP1 | CP1 | W3 | 0 | 110 | A | A | A | A |
| EXAMPLE 16 | 3 | 1.4 | — | 16 | AP1 | CP1 | W4 | 0 | 110 | A | A | A | A |
| EXAMPLE 17 | 3 | 1.4 | — | 17 | AP1 | CP1 | W5 | 0 | 110 | A | A | B | A |
| EXAMPLE 18 | 3 | 1.4 | — | 18 | AP1 | CP3 | W6 | 0 | 7 | B | A | A | C |
| COMPARATIVE | 5 | 0.0 | — | 19 | AP1 | CP1 | W1 | 0 | 110 | D | A | A | A |
| EXAMPLE 1 | | | | | | | | | | | | | |
| COMPARATIVE | 6 | 0.0 | 0.7 | 20 | AP1 | CP1 | W1 | 0 | 110 | A | D | A | A |
| EXAMPLE 2 | | | | | | | | | | | | | |
| COMPARATIVE | 1 | 0.7 | — | 21 | AP6 | CP1 | W1 | 50 | 110 | A | A | D | A |
| EXAMPLE 3 | | | | | | | | | | | | | |
| COMPARATIVE | 1 | 0.7 | — | 22 | AP7 | CP1 | W1 | 100 | 110 | A | A | D | A |
| EXAMPLE 4 | | | | | | | | | | | | | |

*1: RELEASE AGENT DISPERSION LIQUID
*2: LOW TEMPERATURE FIXABILITY
In the above table, “Al” represents aluminum, “Si” represents silicon, and “Li” represents lithium.
In the above table, “BPA content” represents the content percentage of structural units derived from bisphenol A derivatives in amorphous polyesters.

### (J.5) General Remarks

As is clear from Table VI, it is found that examples are excellent as compared with comparative examples, image failure such as black spots and fogging is suppressed, and low-temperature fixing ability and heat resistance are excellent, thus image failure can be suppressed. As is shown above, the embodiments of the present invention have been described and illustrated in detail. However, the disclosed embodiments are made for purposes of illustration and example only and are not intended to be limiting. The scope of the present invention is to be interpreted by the terms of the appended claims.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2023-073381, filed on Apr. 27, 2023, including description, claims, drawings and abstract is incorporated herein by reference.

What is claimed is:

1. An image forming system comprising:
an electrostatic charge image developing toner; and
a developing sleeve configured to convey the electrostatic charge image developing toner,
wherein,
a toner particle included in the electrostatic charge image developing toner contains an amorphous polyester,
the amorphous polyester is a polycondensate of a polyvalent carboxylic acid and a polyhydric alcohol,
a content percentage of a structural unit derived from a bisphenol A derivative in the amorphous polyester is 10 mol % or less with respect to all structural units derived from the polyhydric alcohol, and
the developing sleeve includes an aluminum alloy including more than 0.6% by mass of silicon.

2. The image forming system according to claim 1, wherein a member that generates a magnetic flux is included inside the developing sleeve.

3. The image forming system according to claim 1, wherein the toner particle includes a crystalline resin.

4. The image forming system according to claim 3,
wherein, the crystalline resin contains a crystalline polyester, and
the crystalline polyester is a polycondensate of an aliphatic dicarboxylic acid having 6 to 14 carbon atoms and an aliphatic diol having 6 to 14 carbon atoms.

5. The image forming system according to claim 1, wherein the polyhydric alcohol contains an aliphatic polyhydric alcohol having 5 or more carbon atoms.

6. The image forming system according to claim 1, wherein a silicon content in the aluminum alloy is more than 0.8% by mass.

7. The image forming system according to claim 1, wherein the toner particle includes a release agent having a melting point in a range of 70 to 91° C.

8. The image forming system according to claim 1, wherein the toner particle includes, as an external additive, a silica particle having a mean particle diameter within a range of 90 to 130 nm.

9. An image forming method comprising:
image forming using an electrostatic charge image developing toner and a developing sleeve that conveys the electrostatic charge image developing toner,
wherein,
a toner particle including the electrostatic charge image developing toner includes an amorphous polyester that is a polycondensate of a polyvalent carboxylic acid and a polyhydric alcohol,
a content percentage of a structural unit derived from a bisphenol A derivative in the amorphous polyester is 10 mol % or less with respect to all structural units derived from the polyhydric alcohol, and
the developing sleeve includes an aluminum alloy including more than 0.6% by mass of silicon.
